(19) United States
(12) Patent Application Publication
(10) Pub. No.: US 2025/0358863 A1
(43) Pub. Date: Nov. 20, 2025

(54) METHOD FOR RANDOM ACCESS, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Jianfei CAO, Dongguan (CN); Zhe LIU, Dongguan (CN); Zhihua SHI, Dongguan (CN)

(21) Appl. No.: 19/004,424

(22) Filed: Dec. 29, 2024

Related U.S. Application Data
(63) Continuation of application No. PCT/CN2022/108518, filed on Jul. 28, 2022.

(51) Int. Cl. H04W 74/0833; H04L 5/00

(52) U.S. Cl. CPC H04W 74/0833; H04L 5/0035

(57) ABSTRACT

A method for random access, a terminal device, and a network device are provided. The method includes the following. A terminal device determines a random access parameter for at least one target transmission reception point (TRP), where each of the at least one target TRP is a TRP among multiple TRPs, where an uplink between the TRP and the terminal device is in an out-of-sync state, and at least part of random access parameters for different TRPs are different. The terminal device transmits a physical random access channel (PRACH) to the at least one target TRP based on the random access parameter for the at least one target TRP, where the PRACH is used to obtain timing advance (TA) information for the at least one target TRP.

### CROSS-REFERENCE TO RELATED APPLICATION(S)

This application is a continuation of International Application No. PCT/CN2022/108518, filed Jul. 28, 2022, the entire disclosure of which is incorporated herein by reference.

### TECHNICAL FIELD

Embodiments of the disclosure relate to the field of mobile communication technology, and specifically to a method for random access, a terminal device, and a network device.

### BACKGROUND

In order to reduce influences brought by a delay in spatial transmission of a signaling between a terminal device and a network device (for example, a base station), the terminal device can transmit a physical random access channel (PRACH) to the network device, so that the network device performs uplink delay measurement based on the PRACH and determines timing advance (TA) information for the terminal device. In this way, the terminal device can transmit an uplink channel or signal according to the TA information. In addition, the multiple transmission reception point (multi-TRP) transmission technology refers to simultaneous communication between multiple TRPs and one terminal device over the same carrier.

Currently, a new radio (NR) protocol supports only transmission of the PRACH to one TRP from the terminal device. However, since distances between the terminal device and different TRPs may be different, there may be a relatively large synchronization error for different TRPs. There is no explicit solution regarding how to perform uplink synchronization for different TRPs.

### SUMMARY

A method for random access, a terminal device, and a network device are provided in embodiments of the disclosure.

A method for random access is provided in embodiments of the disclosure. The method includes the following. A terminal device determines a random access parameter for at least one target transmission reception point (TRP), where each of the at least one target TRP is a TRP among multiple TRPs, where an uplink between the TRP and the terminal device is in an out-of-sync state, and at least part of random access parameters for different TRPs are different. The terminal device transmits a physical random access channel (PRACH) to the at least one target TRP based on the random access parameter for the at least one target TRP, where the PRACH is used to obtain timing advance (TA) information for the at least one target TRP.

A terminal device is provided in embodiments of the disclosure. The terminal device includes a transceiver, a processor coupled with the transceiver, and a memory storing a computer program. The computer program, when executed by the processor, causes the terminal device to: determine a random access parameter for at least one target TRP, where each of the at least one target TRP is a TRP among multiple TRPs, where an uplink between the TRP and the terminal device is in an out-of-sync state, and at least part of random access parameters for different TRPs are different; and transmit a PRACH to the at least one target TRP based on the random access parameter for the at least one target TRP, where the PRACH is used to obtain TA information for the at least one target TRP.

A network device is provided in embodiments of the disclosure. The network device includes a transceiver, a processor coupled with the transceiver, and a memory storing a computer program. The computer program, when executed by the processor, causes the network device to: receive, through each of at least one target TRP, a PRACH transmitted by a terminal device to each of the at least one target TRP. The PRACH is used to obtain TA information for each of the at least one target TRP, and each of the at least one target TRP is a TRP among multiple TRPs, where an uplink between the TRP and the terminal device is in an out-of-sync state.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiment described herein.

### BRIEF DESCRIPTION OF THE DRAWINGS

The accompanying drawings described herein are intended for further understanding of the disclosure and constitute part of the disclosure. Exemplary embodiments of the disclosure as well as elaborations thereof are intended for explaining, rather than limiting, the disclosure. In the accompanying drawings:

FIG. 1 is a schematic architectural diagram of a communication system provided in embodiments of the disclosure.

FIG. 2 is a schematic diagram illustrating a signaling structure of a medium access control (MAC) random access response (RAR) provided in embodiments of the disclosure.

FIG. 3 is a schematic diagram illustrating a structural relationship between frames provided in embodiments of the disclosure.

FIG. 4 is a schematic diagram of an application scenario provided in embodiments of the disclosure.

FIG. 5 is schematic flow chart 1 of a method for random access provided in embodiments of the disclosure.

FIG. 6 is schematic flow chart 2 of a method for random access provided in embodiments of the disclosure.

FIG. 7A is schematic diagram 1 of grouping provided in embodiments of the disclosure.

FIG. 7B is schematic diagram 2 of grouping provided in embodiments of the disclosure.

FIG. 8 is schematic flow chart 3 of a method for random access provided in embodiments of the disclosure.

FIG. 9A is a schematic diagram illustrating frequency division multiplexing (FDM) repetitions provided in embodiments of the disclosure.

FIG. 9B is a schematic diagram illustrating time division multiplexing (TDM) repetitions provided in embodiments of the disclosure.

FIG. 9C is a schematic diagram illustrating single frequency network (SFN) transmission provided in embodiments of the disclosure.

FIG. 10 is a schematic diagram illustrating random access provided in embodiments of the disclosure.

FIG. 11 is a schematic structural diagram of an apparatus 1100 for random access provided in embodiments of the disclosure.

FIG. 12 is a schematic structural diagram of an apparatus 1200 for random access provided in embodiments of the disclosure.

FIG. 13 is a schematic structural diagram of a communication device provided in embodiments of the disclosure.

FIG. 14 is a schematic structural diagram of a chip provided in embodiments of the disclosure.

FIG. 15 is a schematic block diagram of a communication system provided in embodiments of the disclosure.

### DETAILED DESCRIPTION

The following will describe technical solutions of embodiments of the disclosure with reference to the accompanying drawings of embodiments of the disclosure. Apparently, embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

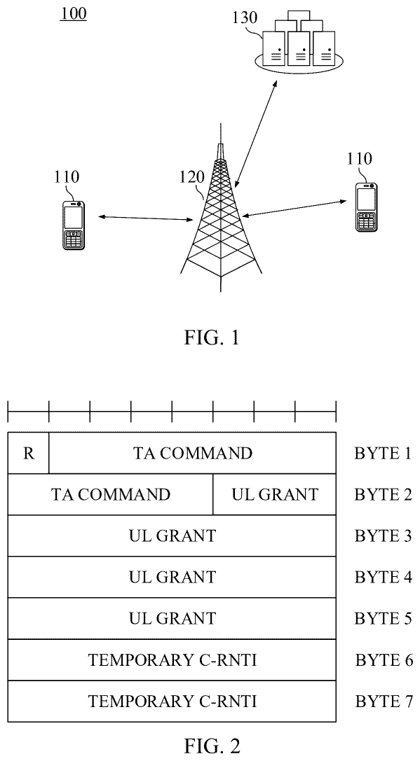

FIG. 1 is a schematic architectural diagram of a communication system provided in embodiments of the disclosure.

As illustrated in FIG. 1, the communication system 100 may include a terminal device 110 and a network device 120. The network device 120 may communicate with the terminal device 110 via an air interface. The terminal device 110 and the network device 120 support multi-service transmission.

It may be understood that, in embodiments of the disclosure, the communication system 100 is used simply for exemplarily illustration rather than limitation. That is, the technical solutions of embodiments of the disclosure are applicable to various communication systems. The various communication systems may include a long term evolution (LTE) system, an LTE time division duplex (TDD) system, a universal mobile telecommunication system (UMTS), an internet of things (IoT) system, a narrow band internet of things (NB-IoT) system, an enhanced machine-type communications (eMTC) system, a 5th generation (5G) communication system (also referred to as a new radio (NR) communication system), or a future communication system.

In the communication system 100 illustrated in FIG. 1, the network device 120 may be an access network device that communicates with the terminal device 110. The access network device can provide a communication coverage for a specific geographical area and communicate with terminal devices 110 (such as a user equipment (UE)) in the coverage area.

The network device 120 may be an evolutional Node B (eNB or eNodeB) in the LTE system, a next generation radio access network (NG RAN) device, a gNB in an NR system, or a radio controller in a cloud radio access network (CRAN). Alternatively, the network device 120 may be a relay station, an access point, an in-vehicle device, a wearable device, a hub, a switch, a bridge, a router, or a network device in a future evolved public land mobile network (PLMN).

The terminal device 110 may be any terminal device, which includes, but is not limited to, a terminal device that is connected with the network device 120 or other terminal devices in a wired or wireless manner.

For example, the terminal device 110 may refer to an access terminal, a UE, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, an IoT device, a satellite handheld terminal, a wireless local loop (WLL) station, a personal digital assistant (PDA), a handheld device with wireless communication functions, a computing device, other processing devices coupled with a wireless modem, an in-vehicle device, a wearable device, a terminal device in a 5G network, a terminal device in the future evolved PLMN, etc.

The terminal device 110 can be configured for device to device (D2D) communication.

The wireless communication system 100 may further include a core network device 130 that communicates with a base station. The core network device 130 may be a 5G core (5GC) device, an access and mobility management function (AMF) device, an authentication server function (AUSF) device, a user plane function (UPF) device, or a session management function (SMF) device. Optionally, the core network device 130 may also be an evolved packet core (EPC) device in the LTE network such as a session management function+core packet gateway (SMF+PGW-C) device. It may be understood that, the SMF+PGW-C device can implement functions of both SMF and PGW-C. With the evolution of the network, the core network device may also have other names, or a new network entity can be formed by dividing functions of the core network, which will not be limited in embodiments of the disclosure.

Various functional units in the communication system 100 may establish a connection with one another via a next generation (NG) interface for communication.

For example, the terminal device establishes an air interface connection with the access network device via an NR interface to transmit user-plane data and control-plane signaling. The terminal device can establish a control-plane signaling connection with the AMF device via NG interface 1 (N1 for short). The access network device, e.g., a next generation wireless access base station (gNB), can establish a user-plane data connection with the UPF device via NG interface 3 (N3 for short). The access network device can establish a control-plane signaling connection with the AMF device via NG interface 2 (N2 for short). The UPF device can establish a control-plane signaling connection with the SMF device via NG interface 4 (N4 for short). The UPF device can exchange user-plane data with a data network via NG interface 6 (N6 for short). The AMF device can establish a control-plane signaling connection with the SMF device via NG interface 11 (N11 for short). The SMF device can establish a control-plane signaling connection with a policy control function (PCF) device via NG interface 7 (N7 for short).

FIG. 1 exemplarily illustrates one base station, one core network device, and two terminal devices. Optionally, the wireless communication system 100 may include multiple base stations and there can be other quantities of terminal devices in a coverage area of each of the base stations, which will not be limited in embodiments of the disclosure.

It may be noted that FIG. 1 only illustrates a system to which the disclosure is applicable by way of example, and certainly, the method illustrated in embodiments of the disclosure may also be applicable to other systems. In addition, the terms “system” and “network” in this disclosure are often used interchangeably. The term “and/or” in this disclosure is simply an illustration of an association relationship of associated objects, indicating that three relationships can exist, for example, A and/or B, which can indicate the existence of A alone, A and B together, and B alone. In addition, the character “/” in this disclosure generally indicates that associated objects are in an “or” relationship. It may also be understood that the “indication” referred to in embodiments of the disclosure may be a direct indication, an indirect indication, or an indication indicating an associated relation. For example, A indicates B, which can mean that A indicates B directly, e.g., B can be obtained through A, can also mean that A indicates B indirectly, e.g., A indicates C, and B can be obtained through C, or can further mean that A and B have an associated relation. It may also be understood that the “correspondence” mentioned in embodiments of the disclosure may represent a direct correspondence or indirect correspondence between the two, may also represent an associated relation between the two, or may further represent a relation of indicating and being indicated, a relation of configuring and being configured, or other relations. It may also be understood that, “pre-definition” or “pre-defined rule” mentioned in embodiments of the disclosure may be implemented by pre-storing corresponding codes, tables, or other modes indicating relevant information in a device (for example, including a terminal device and a network device), and specific embodiments are not limited in the disclosure. For example, pre-definition may refer to definition in a protocol. It may also be understood that, in embodiments of the disclosure, “protocol” may refer to a standard protocol in the field of communication, and may include, for example, an LTE protocol, an NR protocol, and a related protocol applicable to a future communication system, which is not limited in the disclosure.

For better understanding of technical solutions of embodiments of the disclosure, the following describes the related art of embodiments of the disclosure. The related art below, as an optional solution, can be arbitrarily combined with the technical solutions of embodiments of the disclosure, which shall all belong to the protection scope of embodiments of the disclosure.

In the current NR system, the terminal device can be configured with up to 4 timing advance groups (TAGs) in a cell group (CG).

In actual application, the CG may contain multiple serving cells, and each of the serving cells is assigned with one TAG identity (ID). A TA timer TimeAlignmentTimer is configured per TAG and is maintained by both the network device and the terminal device. Before the TA timer expires, the network device and the terminal device consider that the uplink between the network device and the terminal device is in an in-sync state. When the TA timer expires, the terminal device and the network device may consider that the uplink between the terminal device and the network device is in an out-of-sync state. In addition, the TA timer can be reset only when the network device adjusts a TA value through a medium access control (MAC) control element (CE) or other signaling within the running time of the TA timer. For example, in a case where the value of the TA timer is configured as 500 milliseconds (ms), the network device needs to update/adjust the TA value for the terminal device once within 500 ms. Otherwise, the terminal device may consider that the uplink between the terminal device and the network device is out-of-sync, and initiate random access to the network device.

It may be understood that, during initial access (to a cell) of the terminal device, upon transmission of a PRACH to the network device by the terminal device, the terminal device expects the network device to transmit a TA indication to the terminal device through an MAC random access response (RAR) in a certain time window.

Reference is made to FIG. 2 which is a schematic diagram illustrating a signaling structure of an MAC RAR. The MAC RAR may contain a TA command, an uplink grant, a temporary cell radio network temporary identifier (C-RNTI), and reserved information R.

It may be understood that, the terminal device can obtain an initial TA according to the received MAC RAR.

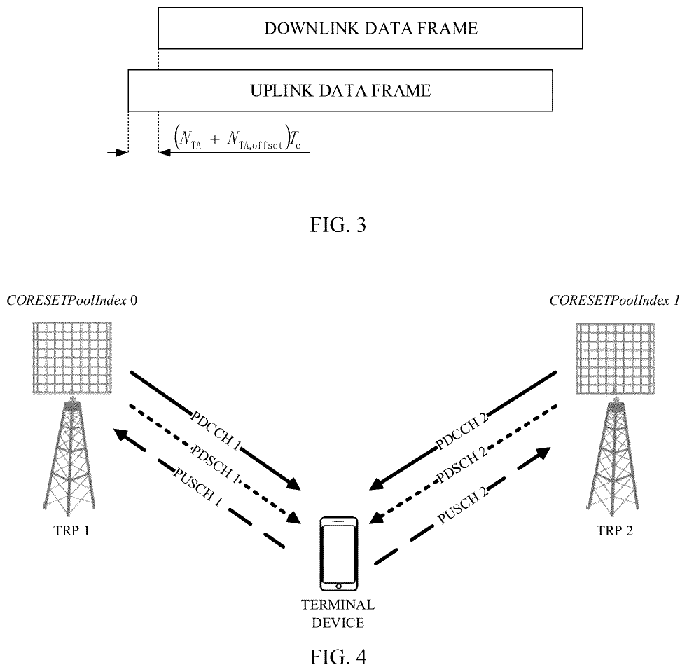

Reference is made to FIG. 3 which is a schematic diagram illustrating a structural relationship between frames. In a case where the terminal device operates in a single transmission reception point (single-TRP) mode, a reference point of a TA for the terminal device is the start of reception of a downlink data frame, and the terminal device transmits an uplink channel or signal at a time (N_{TA}+N_{TA,offset})*T_{C} ahead of the reference point.

N_{TA,offset} is a TA offset configured for a current serving cell. It may be understood that, one TA offset may be pre-configured for each serving cell in a CG. T_{C} is a minimum time unit in an NR system, and T_{C}=1/(4096*480 kHz). In addition, a TA adjustment N_{TA} is determined based on the pre-configured TA offset.

In some embodiments, N_{TA} may be determined by a differential adjustment provided in an MAC CE transmitted by the network device. In other words, the current TA adjustment (new TA adjustment) is determined by performing forward or backward adjustment in time on the previous (old) TA. The calculation formula is N_{(TA}_{_{new}}₎=N_{(TA}_{_{old)}}+(T_{A}−31)*16*64*/2^{μ}.

In some other embodiments, N_{TA} may be an adjustment of an absolute value. In other words, the MAC CE from the network device directly indicates absolute value N_{TA} ranging from 0 to 3846, without consideration of the previous TA value. Specifically, an adjustment range of N_{TA} relative to TA is expressed as N_{TA}=T_{A}*16*64*2^{μ}.

In order to enhance uplink coverage and transmission reliability, the current NR system can support multi-TRP based physical uplink control channel (PUCCH) repetitions and physical uplink shared channel (PUSCH) repetitions. Specifically, the terminal device can transmit to different TRPs PUCCHs/PUSCHs carrying the same content.

For the PUSCH repetitions, the current NR system supports multi-PUSCH repetitions based on single downlink control information (sDCI) and multi-PUSCH repetitions based on multi-DCI (mDCI).

During the PUSCH repetitions, the terminal device sequentially transmits a PUSCH to different TRPs by using one TA. Since an ideal backhaul for connection may not exist between multiple TRPs, each of the multiple TRPs performs independent scheduling for the terminal device, and such an operation may lead to an overlap in time between PUSCHs/PUCCHs for different TRPs. Therefore, different TA updates or indications are required for different TRPs.

Exemplarily, reference is made to FIG. 4 which is a schematic diagram of an application scenario. In an intra-cell multiple DCI-multi-TRP (mDCI-mTRP) scenario, TRP#1 and TRP#2 use the same physical cell identity (PCI). Each TRP may schedule transmission of PDSCH/PUSCH through respective DCI. It may be noted that, in the mDCI-mTRP scenario, control resource sets (CORESETs) may be grouped, and each group corresponds to one of different TRPs. The network device can configure grouping of CORESETs through a parameter CORESETPoolIndex in a radio resource control (RRC) message. CORESETs with CORESETPoolIndex “0” are grouped into a group, which corresponds to one TRP, and CORESETs with CORESETPoolIndex “1” are grouped into another group, which corresponds to another TRP. It may be noted that, when the network device does not configure CORESETPoolIndex for a CORESETE, the default value of CORESETPoolIndex is “0”.

In addition, in an inter-cell mDCI-mTRP scenario, TRP#1 may be a TRP which the terminal device accesses during initial access, the terminal device has obtained uplink and downlink synchronization with TRP#1, and TRP#1 has a dedicated PCI#1. For other TRPs, since the network device can select from up to 7 TRPs one TRP to additionally serve for uplink transmission of the terminal device, PCIs of these TRPs are different from the PCI of TRP#1, and uplink and downlink synchronization is often not established in advance between these TRPs and the terminal device.

In the current TA-indication technology, the TA can only be adjusted in a granularity of a TAG, where the smallest unit of the TAG is a serving cell. In addition, the NR system currently supports only random access of the terminal device to one TRP, and multiple TRPs in one TAG uses the same TA to receive uplink data. Since distances between the terminal device and different TRPs may be different, there may be a relatively large synchronization error for different TRPs. However, there is no explicit solution regarding how to perform uplink synchronization for different TRPs and obtain a TRP-specific TA.

In this case, a mechanism for simultaneous PUCCH/PUSCH transmission from multiple antenna panels of the terminal device to multiple TRPs is currently under discussion in the 3rd generation partnership project (3GPP). Even under the configuration of multiple uplink transmitting antenna panels and multi-TRP reception, the terminal device still can use only one TA to perform transmission in advance in a serving cell. Apparently, such a limitation needs to be broken, that is, obtaining and indication of the TRP-specific TA needs to be supported.

Based on this, a method for random access is provided in embodiments of the disclosure. The terminal device determines a random access parameter for at least one target TRP, where each target TRP is a TRP among multiple TRPs, where an uplink between the TRP and the terminal device is in an out-of-sync state. The terminal device transmits a PRACH to the at least one target TRP based on the random access parameter for the at least one target TRP, where the PRACH is used to obtain TA information for the at least one target TRP. In other words, the terminal device may initiate, based on a random access parameter for a target TRP which is in out-of-sync with the terminal device (“out-of-sync target TRP”), random access to the target TRP to obtain TA information specific to the target TRP. As such, the terminal device can access a target TRP which is in uplink out-of-sync with the terminal device (“uplink out-of-sync target TRP”), thereby ensuring correct transmission of uplink data.

For better understanding of technical solutions of embodiments of the disclosure, the technical solutions of embodiments of the disclosure will be elaborated first. The related art above, as an optional solution, can be arbitrarily combined with the technical solutions of embodiments of the disclosure, which shall all belong to the protection scope of embodiments of the disclosure. Embodiments of the disclosure include at least part of the following.

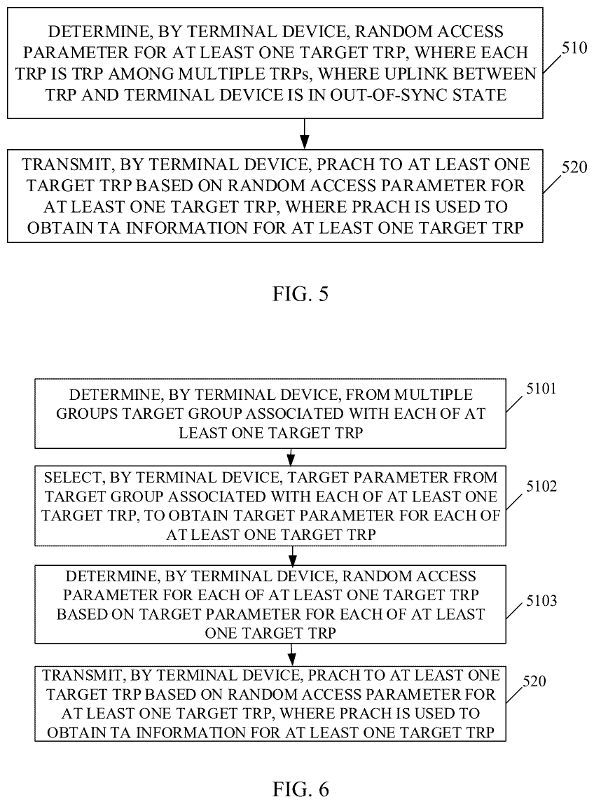

FIG. 5 is schematic flow chart 1 of a method for random access provided in embodiments of the disclosure. As illustrated in FIG. 5, the method includes the following.

At 510, a terminal device determines a random access parameter for at least one target TRP. Each target TRP is a TRP among multiple TRPs, where an uplink between the TRP and the terminal device is in an out-of-sync state.

At 520, the terminal device transmits a PRACH to the at least one target TRP based on the random access parameter for the at least one target TRP. The PRACH is used to obtain TA information for the at least one target TRP.

It may be understood that, the terminal device can simultaneously communicate with the multiple TRPs (two or more TRPs) over the same carrier. Multi-TRP transmission may include intra-cell multi-TRP transmission and inter-cell multi-TRP transmission. In an intra-cell multi-TRP transmission scenario, the multiple TRPs belong to the same cell and have the same PCI. In an inter-cell multi-TRP transmission scenario, up to 7 TRPs with different PCIs can communicate with the terminal device.

In embodiments of the disclosure, after determining that the uplink between the terminal device and the at least one target TRP is out-of-sync, the terminal device may transmit the PRACH to a corresponding target TRP according to a random access parameter for each of the at least one target TRP, so as to expect to obtain TA information specific to each target TRP.

Optionally, the terminal device may determine the at least one target TRP according to a time-alignment timer (TimeAlignmentTimer). Alternatively, the terminal device may determine the at least one target TRP according to an indication from the network device, which will not be limited in embodiments of the disclosure. That is, random access for the at least one target TRP may be triggered by the time-alignment timer or may be triggered by the network device through indication information.

In some embodiments, the terminal device may be configured with one or more time-alignment timers (TimeAlignmentTimer). Each of the time-alignment timers may be associated with at least one of the multiple TRPs. When one of the time-alignment timers expires, the terminal device may determine that the uplink between the terminal device and each TRP associated with the expired time-alignment timer is out-of-sync. As such, the terminal device can determine an uplink out-of-sync TRP(s) as a target TRP(s).

Exemplarily, the terminal device may be configured with one time-alignment timer, and the multiple TRPs may be associated with the time-alignment timer. When the time-alignment timer expires, the terminal device may determine that the uplink between the terminal device and each of the TRPs is out-of-sync. Alternatively, the terminal device may be configured with time-alignment timers, each of which corresponds to one of the TRPs. When any one of the time-alignment timers expires, the terminal device may determine that the uplink between the terminal device and a TRP associated with the time-alignment timer is out-of-sync.

In some other embodiments, the terminal device may receive second indication information transmitted by the network device, where the second indication information indicates a target TRP, where an uplink between the target TRP and the terminal device is in an out-of-sync state. Exemplarily, the network device may indicate, through a physical downlink control channel (PDCCH) order, to the terminal device at least one uplink out-of-sync target TRP.

Optionally, the random access parameter includes at least one of a preamble, a transmission beam, or a random access (RACH) occasion (RO).

It may be understood that, the terminal device may transmit the preamble to the TRP through the PRACH, so as to obtain uplink synchronization. In addition, the transmission beam refers to a beam for transmission of the PRACH by the terminal device. The transmission beam may be determined according to a synchronization signal and PBCH block (SSB) for the TRP received by the terminal device. Generally, the terminal device may select an appropriate SSB and use a beam for reception of the SSB to transmit the PRACH. The RO refers to a time-frequency resource used by the terminal device to transmit a corresponding PRACH after selection of the SSB.

At least part of random access parameters for different TRPs are different. Exemplarily, for different TRPs, preambles and ROs for transmission of the PRACHs by the terminal device to the different TRPs may be the same, while transmission beams for transmission of the PRACHs by the terminal device to the different TRPs may be different.

Accordingly, the network device receives, through each of the at least one target TRP, the PRACH transmitted by the terminal device to each of the at least one target TRP.

It may be understood that, the network device may measure uplink delay for the terminal device according to the PRACH transmitted by the terminal device. In embodiments of the disclosure, the network device may receive the PRACH from the terminal device through each of the at least one target TRP, and each of the at least one target TRP may measure uplink delay information for the terminal device according to the received PRACH, so as to obtain TA information specific to each target TRP. The network device may transmit the TA information for each target TRP to the terminal device through each target TRP.

As above mentioned, the terminal device may initiate, based on a random access parameter for an out-of-sync target TRP, random access to the target TRP to obtain TA information specific to the target TRP. As such, the terminal device can access the uplink out-of-sync target TRP, thereby ensuring correct transmission of uplink data to the target TRP.

In embodiments of the disclosure, there are multiple manners for the terminal device to determine the at least one target TRP. The following will describe two implementations thereof.

Manner 1, as illustrated in FIG. 6, at 510, determining, by the terminal device, the random access parameter for the at least one target TRP can be implemented through the following operations.

At 5101, the terminal device determines from multiple groups a target group associated with each of the at least one target TRP.

At 5102, the terminal device selects a target parameter from the target group associated with each of the at least one target TRP, to obtain a target parameter for each of the at least one target TRP.

At 5103, the terminal device determines a random access parameter for each of the at least one target TRP based on the target parameter for each of the at least one target TRP.

The multiple groups include multiple signal groups and/or multiple resource groups, the multiple signal groups contain signals for downlink synchronization, and the multiple resource groups contain resources for random access.

It may be understood that, in a multi-TRP transmission scenario, the network device configures a certain number of signals for each TRP, so that the terminal device can perform downlink synchronization or downlink data transmission. In embodiments of the disclosure, a signal may be an SSB, a tracking reference signal (TRS), a channel state information-reference signal (CSI-RS), or the like, which will not be limited in embodiments of the disclosure.

Exemplarily, on an FR2 frequency band, the network device can configure up to 64 SSBs, and each SSB has an index. After selecting an appropriate SSB through measurement by the terminal device, the terminal device transmits the PRACH based on the SSB, so that the network device can measure a TA value for the terminal device under the selected SSB. It may be noted that, the appropriate SSB means that a reference signal received power (RSRP) of the SSB is greater than or equal to a specified threshold.

In the current multi-TRP transmission scenario, the multiple TRPs share the above 64 SSBs. The terminal device cannot determine which SSBs correspond to TRPs which are in an uplink in-sync state and which SSBs correspond to TRPs which are in an uplink out-of-sync state. Based on this, in a case where the terminal device initiates random access to an uplink out-of-sync TRP, the selected SSB may be from the SSBs for the TRPs which are in the uplink in-sync state. In a case where the terminal device continues to transmit the PRACH based on the SSB, the terminal device cannot achieve uplink synchronization with another TRP.

In addition, in the multi-TRP transmission scenario, the network device may also configure for each TRP a certain number of resources for random access, so that the terminal device can transmit the PRACH over the resources. A resource mentioned in embodiments of the disclosure may be an RO resource.

Similarly, in the multi-TRP transmission scenario, in a case where the terminal device initiates random access to an uplink out-of-sync TRP, an RO resource used by the terminal device may be from RO resources for the TRPs which are in an uplink in-sync state. In a case where the terminal device continues to transmit the PRACH to the TRP over the RO resource, the terminal device cannot achieve uplink synchronization with another TRP.

Based on this, in embodiments of the disclosure, the multiple signals for downlink synchronization and/or the multiple resources for random access may be grouped, so as to distinguish different TRPs.

Optionally, the signal groups may include SSB groups and/or TRS groups, the different SSB groups contain SSBs with different indexes, and the different TRS groups contain TRSs with different indexes. The resource groups include RO groups, and the different RO groups contain ROs with different indexes.

Optionally, these signals/resources (which may be any one of SSBs, TRSs, or RO resources) may be grouped according to indexes of the signals/resources. Exemplarily, all the signals/resources (which may be any one of SSBs, TRSs, or RO resources) may be divided into two groups according to whether the indexes are an odd or even number. For example, when the signals are SSBs, 64 SSBs configured in the NR system may be divided into two SSB groups, namely the first SSB group SSB Group#0={SSB#0, SSB#2, . . . , SSB#62} and the second SSB group SSB Group#1={SSB#1, SSB#3, . . . , SSB#63}. In addition, the signals/resources may be equally divided according to the indexes. For example, the SSBs are still divided into two SSB groups, namely the first SSB group SSB Group#0={SSB#0, SSB#1, . . . , SSB#31} and the second SSB group SSB Group#1={SSB#32, SSB#33, . . . , SSB#63}.

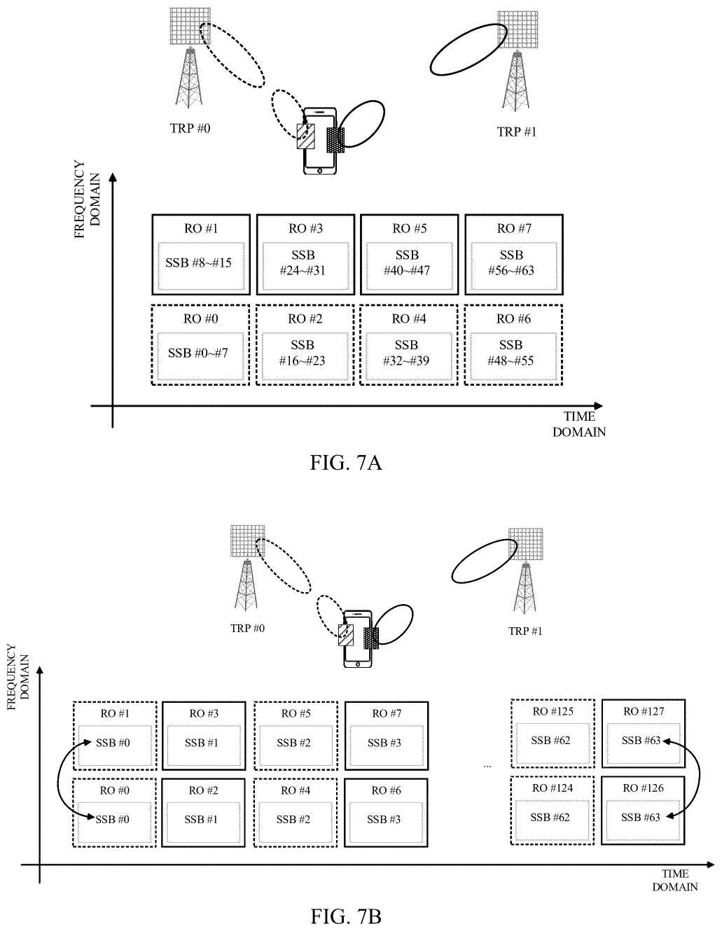

For example, when the signals/resources are RO resources, as illustrated in FIG. 7A, the RO resources may be divided into two groups according to whether the RO resource indexes are an odd or even number, namely the first RO resource group RO Group#0={RO#0, RO#2, . . . , RO#6} and the second RO resource group RO Group#1={RO#1, RO#3, . . . , RO#7}. As illustrated in FIG. 7B, the RO resources may be divided into two groups in an order of the RO resource indexes, namely the first RO resource group RO Group#0={RO#0, RO#1, RO#4, RO#5, . . . , RO#124, RO#125} and the second RO resource group RO Group#1={RO#2, RO#3, RO#6, RO#7, . . . , RO#126, RO#127}.

Optionally, the multiple groups may be pre-defined by a protocol or determined according to pre-configuration information or network configuration information, which will not be limited in embodiments of the disclosure. Exemplarily, the network device may configure the multiple groups for the terminal device through an RRC signaling, or the terminal device may divide multiple signals/resources into multiple groups according to a pre-defined rule (for example, according to odd indexes).

It may be noted that, the multiple groups may be associated/bound with the multiple TRPs, so as to establish a correspondence between the multiple groups and the multiple TRPs. Alternatively, the multiple groups may not be bound with the multiple TRPs, which will not be limited in embodiments of the disclosure.

In an example, in an mDCI-mTRP scenario, the network device groups CORESETs according to a parameter CORESETPoolIndex in an RRC message, and different CORESET groups correspond to different TRPs. That is, CORESETPoolIndex may implicitly indicate an “TRP ID”. Based on this, in order to distinguish different TRPs, the network device can configure the SSB groups via the RRC message, for example, configure the first SSB Group SSB Group#0={SSB Index#A, SSB Index#B, . . . , SSB Index#C} and the second SSB Group SSB Group#1= {SSB Index#X, SSB Index#Y, . . . , SSB Index#Z} via the RRC message. In addition, the network device may configure SSB Group#0 to be bound with CORESETPoolIndex#0, and SSB Group#1 to be bound/associated with CORESETPoolIndex #1. As such, one TRP may be bound/associated with one SSB group at the protocol level.

Similarly, the network device may also configure the TRS groups/RO resource groups via the RRC message, and bind/associate the different TRS groups/RO resource groups with CORESETPoolIndex, so that one TRP may be bound/associated with one TRS group/RO resource group.

In some embodiments, in a single DCI-multi-TRP (sDCI-mTRP) scenario, the network device may implicitly inform the terminal device of a TRP corresponding to each SSB group by configuring no parameter CORESETPoolIndex in the RRC message. The network device may divide all the SSBs into multiple SSB groups according to the pre-defined rule and indicate the multiple SSB groups to the terminal device. In such a way, during selection of an SSB, the terminal device can perform selection on other SSB groups except a group to which an SSB for an uplink in-sync TRP belongs. In this way, even though the SSB groups have no correspondence with the TRPs, SSB groups for different TRPs can also be distinguished.

Similarly, the network device may divide all the TRSs into multiple TRS groups according to the pre-defined rule and indicate the multiple TRS groups to the terminal device. The network device may divide all the RO resources into multiple RO resource groups according to the pre-defined rule and indicate the multiple RO resource groups to the terminal device.

In some embodiments, in addition to the manner of configuring via the RRC message described above in the example, the terminal device and the network device may also perform grouping according to the pre-defined rule. Further, the terminal device and the network device may respectively bind the multiple groups grouped according to a preset rule with the multiple TRPs, so as to establish a correspondence. Alternatively, the terminal device and the network device may not bind the multiple groups grouped according to the preset rule with the multiple TRPs.

In an embodiment of the disclosure, the multiple groups are in one-to-one correspondence with the multiple TRPs. Correspondingly, at 5101, determining, by the terminal device, from the multiple groups the target group associated with each of the at least one target TRP can be implemented through the following operations. The terminal device selects, based on a first correspondence, from the multiple groups a group associated with each of the at least one target TRP, to obtain the target group associated with each of the at least one target TRP. The first correspondence indicates a correspondence between the multiple groups and the multiple TRPs.

Optionally, the first correspondence between the multiple groups and the multiple TRPs may be pre-defined by a protocol or determined according to pre-configuration information or network configuration information, which will not be limited in embodiments of the disclosure.

It may be understood that, the correspondence between the multiple groups and the multiple TRPs may be configured by the network device through the RRC signaling or may be determined by the network device and the terminal device according to the pre-defined rule. For specific configuration manners and determination manners, reference can be made to the description of the above embodiments, which will not be repeated herein for the sake of simplicity.

It may be noted that, the first correspondence between the multiple groups and the multiple TRPs may be determined based on a binding between the multiple groups and multiple CORESETPoolIndex.

In embodiments of the disclosure, when the terminal device needs to perform uplink synchronization for the target TRP, that is, when the terminal device transmits the PRACH to the target TRP, the terminal device may determine the target group for the target TRP according to the first correspondence. Next, the terminal device determines a random access parameter specific to the target TRP by selecting an appropriate parameter from the target group.

For example, when the groups are SSB groups, in a case where the terminal device needs to perform uplink synchronization for the target TRP, the terminal device may determine an SSB group for the target TRP according to the first correspondence and select from the SSB group an appropriate SSB as a downlink time reference for PRACH transmission. Further, the terminal device may determine a preamble and an RO resource associated with the SSB. In this way, the terminal device can transmit the PRACH to the target TRP according to the RO resource and the preamble determined based on the SSB.

For example, when the groups are RO resource groups, in a case where the terminal device needs to perform uplink synchronization for the target TRP, the terminal device may select an RO resource from RO resources associated with the target TRP and determine an SSB corresponding to the RO resource as a downlink time reference for PRACH transmission. Further, the terminal device transmits the PRACH to the target TRP based on the RO resource, the SSB corresponding to the RO resource, and a preamble associated with the SSB.

It may be noted that, the RO resource may correspond to the SSB. Upon selection of the SSB, the terminal device naturally selects a corresponding RO. It may be understood that, upon selection of an appropriate SSB, the terminal device may transmit the PRACH over an RO resource associated with the SSB. Based on this, regarding the RO resource, when the network device deploys the SSB and the TRP, the network device may also deploy a corresponding RO resource for each SSB.

Optionally, the SSB may correspond to the RO in the following two manners. One is that the multiple SSBs correspond to one RO resource, and the other one is that one SSB corresponds to the multiple RO resources.

Exemplarily, in a case where the multiple SSBs correspond to one RO resource, as illustrated in FIG. 7A, in the first RO resource group, RO Group#0={RO#0, RO#2, . . . , RO#6}, RO#0 may correspond to SSB#0 to SSB#7, RO#2 may correspond to SSB#16 to SSB#23, RO#4 may correspond to SSB#32 to SSB#39, and RO#6 may correspond to SSB#48 to SSB#55. In addition, in the second RO resource group, RO Group#1={RO#1, RO#3, . . . , RO#7}, RO#1 may correspond to SSB#8 to SSB#15, RO#3 may correspond to SSB#24 to SSB#31, RO#5 may correspond to SSB#40 to SSB#47, and RO#7 may correspond to SSB#56 to SSB#63.

In a case where one SSB corresponds to the multiple RO resources, as illustrated in FIG. 7B, in the first RO resource group, RO Group#0={RO#0, RO#1, RO#4, RO#5, . . . , RO#124, RO#125}, RO#0 and RO#1 may correspond to SSB#0, RO#2 and RO#3 may correspond to SSB#1, and similarly, RO#126 and RO#127 may correspond to SSB#63.

Exemplarily, in the scenario illustrated in FIG. 7A, when the terminal device needs to perform uplink synchronization for TRP#0, the terminal device may select RO#7 from RO Group#0 (RO Group#0={RO#0, RO#2, . . . , RO#6}) associated with TRP#0 and select from SSBs corresponding to RO#0 SSB#63 as a downlink time reference for PRACH transmission. In addition, the terminal device transmits the PRACH to TRP#0 based on SSB#63, RO#0, and a preamble corresponding to SSB#63. In the scenario illustrated in FIG. 7B, when the terminal device needs to perform uplink synchronization for TRP#0, the terminal device may select RO#125 from RO Group#0 (RO Group#0={RO#0, RO#1, RO#4, RO#5, . . . , RO#124, RO#125}) associated with TRP#0 and determine SSB#62 corresponding to RO#125 as a downlink time reference for PRACH transmission.

It may be noted that, in a case where multiple ROs are associated with one SSB, as illustrated in FIG. 7B, the terminal device may automatically select an RO or randomly select an RO for transmission.

As can be seen, in embodiments of the disclosure, the signals for downlink synchronization and/or the resources for random access are grouped, and different groups are associated with different TRPs. As such, the terminal device can distinguish different TRPs by searching for a target group associated with the uplink out-of-sync target TRP. Further, during determination of the random access parameter according to parameters in the target group, the terminal device can determine the random access parameter specific to the target TRP. In this way, the terminal device will not repeat transmission of the PRACH to a TRP which has been in synchronization with the terminal device (“synchronized TRP”).

In another embodiment of the disclosure, the multiple groups have no correspondence with the multiple TRPs. Based on this, at 5101, determining, by the terminal device, from the multiple groups the target group associated with each of the at least one target TRP can be implemented in the following manners. The terminal device determines a group to which a parameter associated with a first TRP belongs, to obtain a reference group, where the first TRP is a TRP among the multiple TRPs, where an uplink between the TRP and the terminal device is in an in-sync state. The terminal device determines other groups except the reference group as target groups associated with the at least one target TRP, where each of the at least one target TRP corresponds to one of the other groups.

In embodiments of the disclosure, in a case where the multiple groups are not bound/associated with the multiple TRPs, the terminal device may remove from the multiple groups a group associated with a TRP which has been in uplink synchronization with the terminal device (“uplink synchronized TRP”), and determine the remaining other groups as the target groups associated with the at least one target TRP. It may be understood that, since the uplink between the terminal device and the first TRP is in an in-sync state, the terminal device can easily know which group a parameter (for example, any one of an SSB, an TRS, or an RO resource) for accessing the first TRP belongs to.

Exemplarily, as illustrated in FIG. 7A, assuming that an index of an RO resource for accessing the first TRP by the terminal device is RO#0 and RO#0 belongs to the first RO resource group, the terminal device may determine the second RO resource group as the target group associated with the target TRP.

Optionally, one or more first TRPs may be configured, which will not be limited in embodiments of the disclosure.

Optionally, when the number of the remaining other groups except a group associated with a parameter for the first TRP is greater than the number of the at least one target TRP, the terminal device may randomly select, from the other groups, a group(s) of the same number as the at least one target TRP, and determine, from the selected group(s), each target group associated with each target TRP.

Optionally, the number of the multiple TRPs may be the same as the number of the multiple groups. The number of the remaining other groups except the group associated with the parameter for the first TRP may be the same as the number of the at least one target TRP. The terminal device may determine, from multiple groups among the other groups, each target group associated with each target TRP. The terminal device may determine, in an order of group indexes from the multiple groups in the other groups, each target group associated with each of the at least one target TRP. For example, the terminal device determines a group with the lowest index among the other groups as a target group associated with a target TRP with the lowest index, and determines a group with the second lowest index among the other groups as a target group associated with the target TRP with the second lowest index. Alternatively, the terminal device determines the group with the lowest index among the other groups as a target group associated with the target TRP with the highest index, and determines the group with the second lowest index among the other groups as the target group associated with the target TRP with the second highest index, and so on.

As above mentioned, even though the multiple groups have no correspondence with the TRPs, the terminal device still can select random access parameters specific to different target TRPs according to different groups, so as to distinguish different TRPs. As such, the terminal device can access the uplink out-of-sync target TRP, thereby ensuring correct transmission of uplink data to the target TRP.

It may be noted that, for the random access for the target TRP triggered by the time-alignment timer, the random access parameter for the target TRP may be determined in Manner 1. In addition, for the random access for the target TRP triggered by the network device through an indication (for example, a PDCCH order), the random access parameter for the target TRP may also be determined in Manner 1. An application scenario of Manner 1 will not be limited in embodiments of the disclosure.

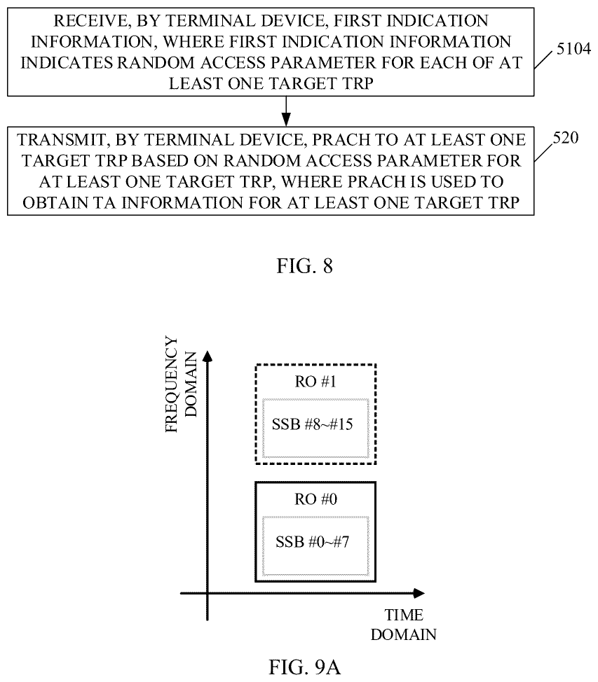

Manner 2, as illustrated in FIG. 8, at 510, determining, by the terminal device, the random access parameter for the at least one target TRP can be implemented through the following operations.

At 5104, the terminal device receives first indication information. The first indication information indicates a random access parameter for each of the at least one target TRP.

In embodiments of the disclosure, the network device may transmit first indication information to the terminal device and indicate, through the first indication information, the random access parameter specific to each of the at least one target TRP.

Optionally, the first indication information may include at least one of: a preamble index for each of the at least one target TRP, an RO resource index for each of the at least one target TRP, an SSB index for each of the at least one target TRP, or PCI information associated with each of the at least one target TRP. The SSB index for each of the at least one target TRP is used to determine a transmission beam for each of the at least one target TRP.

It may be understood that, a transmission beam for transmission of the PRACH by the terminal device may have the same parameter as a beam for reception of the SSB. Therefore, the network device can indicate an index of an SSB for each target TRP, so that the terminal device can determine the transmission beam for transmission of the PRACH.

Optionally, upon expiry of the time-alignment timer, the terminal device may transmit parameter-configuration information to a TRP which is still in uplink in-sync with the terminal device. As such, the network device indicates, according to the parameter-configuration information, to the terminal device the random access parameter specific to the uplink out-of-sync target TRP through the first indication information.

Optionally, the network device may trigger, through the second indication information, random access at the terminal device for the at least one target TRP. In addition, the network device may indicate, through the first indication information, the random access parameter specific to each of the at least one target TRP.

It may be noted that, the second indication information may be the same as or different from the first indication information, which will not be limited in embodiments of the disclosure. Optionally, the first indication information may be carried in first DCI, and the first DCI is used to trigger random access at the terminal device.

It may be understood that, the network device may trigger random access at the terminal device through the specified DCI, i.e., the first DCI. Optionally, the first DCI may be a PDCCH order. In a protocol, the PDCCH order is implemented in a specified DCI format, such as DCI format 1_0 or other evolved formats, which will not be limited in embodiments of the disclosure.

Optionally, when the DCI format 1_0 is scrambled by a cell radio network temporary identifier (C-RNTI) and the frequency domain resource assignment (FDRA) field are of all ones, the terminal device may understand this DCI as a PDCCH order. The PDCCH order may contain a random access preamble index, an uplink/supplementary uplink (UL/SUL) indicator, an SS/PBCH index, a PRACH mask index, and the like. The random access preamble index indicates a preamble for the PRACH, the SS/PBCH index indicates an SSB, and the PRACH mask index indicates an RO associated with the SSB.

It may be noted that, parameters carried in the current PDCCH order can correspond to only one TRP, that is, the current PDCCH order only can trigger random access for a single TRP. In embodiments of the disclosure, the PDCCH order may be extended to carry random access parameters for the multiple TRPs, so as to trigger random access for the multiple TRPs.

In some embodiments, when the first indication information is the PDCCH order, the PDCCH order may contain the following information: a random access preamble index, random access preamble index 2, an SS/PBCH index, SS/PBCH index 2, a PCI, a PRACH mask index, and PRACH mask index 2.

It may be understood that, in addition to the original content, the PDCCH order may further contain a second random access preamble index (random access preamble index 2) indicating another preamble, a second SS/PBCH index (SS/PBCH index 2), a second PRACH mask index (PRACH mask index 2), and PCI information indicating another TRP associated with an SSB.

In some embodiments, when the at least one target TRP is implemented as multiple target TRPs, the first DCI contains a unified transmission configuration indicator (TCI) field, and the unified TCI field indicates an SSB index for any one of the multiple target TRPs.

In actual application, the network device may indicate a beam direction for uplink transmission of the terminal device through the unified TCI field in the PDCCH order. Since the beam direction aims at uplink transmission, a type of unified TCI state is a UL TCI state or a joint TCI state. It may be noted that, since a reference signal in the unified TCI state may be from an intra-cell TRP or an inter-cell TRP, PRACH transmission triggered by the PDCCH order may be directed to the intra-cell TRP or the inter-cell TRP.

It may be understood that, the role of the UL/joint TCI state is to contain an SSB index or a CSI-RS resource index. Based on this, in embodiments of the disclosure, the unified TCI field may be multiplexed, and the SSB index for any one of the multiple target TRPs may be indicated by the unified TCI field.

It may be noted that, SS/PBCH index 2 is in an “or” relationship with the unified TCI field, which means that only one of SS/PBCH index 2 and the unified TCI field exists in the PDCCH order.

Optionally, in a case where the terminal device repeats transmission of the PRACH, when transmission of the PRACH is repeated based on time division multiplexing (TDM) or frequency division multiplexing (FDM), the network device can indicate, by setting the PRACH mask index and PRACH mask index 2 in the first indication information, whether a TDM mode or an FDM mode is to be used for the RO resource.

Optionally, in a case where the terminal device transmits the PRACH over a single frequency network (SFN), the first indication information may include at least one of: a first preamble index, a first RO resource index, an SSB index for each of the at least one target TRP, or PCI information associated with each of the at least one target TRP. The first preamble index indicates a preamble for each of the at least one target TRP. The first RO resource index indicates an RO resource for each of the at least one target TRP. The SSB index for each of the at least one target TRP is used to determine a transmission beam for each of the at least one target TRP.

It may be understood that, the SFN transmission means that the terminal device transmits the same channel over the same time-frequency resource but transmits the same channel to the multiple TRPs using different beams. By doing so, the multiple TRPs can be combined for reception, and thus the reliability of uplink transmission can be improved.

That is, in a case where the terminal device transmits the PRACH over the SFN, only an additional SSB index, i.e., SS/PBCH index 2, and a PCI for the target TRP needs to be contained in the current PDCCH order for the terminal device.

Optionally, in a case where the terminal device transmits the PRACH over the SFN, the first indication information may include at least one of: a preamble index for each of the at least one target TRP, an RO resource index for each of the at least one target TRP, an SSB index for each of the at least one target TRP, or PCI information associated with each of the at least one target TRP. The SSB index for each of the at least one target TRP is used to determine a transmission beam for each of the at least one target TRP.

The preamble index for each target TRP is the same, and the RO resource index for each target TRP is also the same.

It may be noted that, for the random access for the target TRP triggered by the time-alignment timer, in a case where the uplink between at least one of the multiple TRPs and the terminal device is in the in-sync state, the terminal device may determine the random access parameter for the target TRP in Manner 2 (for example, the network device may transmit the first indication information to the terminal device through the TRP which is in the uplink in-sync state). In a case where the uplink between each of the multiple TRPs and the terminal device is out-of-sync, the terminal device may determine the random access parameter for the target TRP in Manner 1. In addition, for the random access for the target TRP triggered by the network device through the indication (for example, the PDCCH order), the random access parameter for the target TRP may also be determined in Manner 2. An application scenario of Manner 1 will not be limited in embodiments of the disclosure.

Optionally, in an embodiment of the disclosure, in a case where one or more of at least one time-alignment timer are determined as expired, the multiple TRPs include a first TRP, and the first TRP is a TRP which is in uplink in-sync with the terminal device, the terminal device determines to clear/release an uplink resource(s) associated with the at least one target TRP, or the terminal device determines to reserve the uplink resource(s) associated with the at least one target TR.

In some embodiments, each of the multiple TRPs may be associated with one time-alignment timer. When the time-alignment timer expires, the terminal device may determine that each of the TRPs is in uplink out-of-sync with the terminal. When the uplink between each of the multiple TRPs and the terminal device is out-of-sync, an MAC layer of the terminal device may perform the following operations on a primary TAG (PTAG) or a secondary TAG (STAG) associated with the time-alignment timer.

In a case where the time-alignment timer (TimeAlignmentTimer) is associated with the PTAG, the MAC layer may perform the following operations:
flush all hybrid automatic repeat reQuest (HARQ) buffers for all serving cells;
notify RRC to release PUCCH for all serving cells (if configured);
notify RRC to release SRS for all serving cells (if configured);
clear any configured downlink assignments and configured uplink grants;
clear any PUSCH resources for semi-persistent CSI reporting;
consider all running time-alignment timers as expired; and
maintain N_{TA} of all TAGS.

Otherwise, in a case where the time-alignment timer is associated with the STAG, for all serving cells belonging to this TAG:
flush all HARQ buffers;
notify RRC to release PUCCH (if configured);
notify RRC to release SRS (if configured);
clear any configured downlink assignments and configured uplink grants;
clear any PUSCH resource for semi-persistent CSI reporting; and
maintain N_{TA} of this TAG.

In some other embodiments, the multiple TRPs may also be associated with different time-alignment timers. In a case where each TRP is associated with one TAG, when any one of the time-alignment timers expires, the terminal device may determine that the uplink between the terminal device and the TRP associated with the time-alignment timer is out-of-sync. In a case where some of the time-alignment timers expire and there is still a time-alignment timer(s) that has not been expired (that is, there is still a TRP(s) which is in uplink in-sync with the terminal device), the MAC layer of the terminal device may have two options. The first one is to clear/release any uplink resources associated with all uplink out-of-sync target TRPs, and the specific operations may include the following.

In a case where the time-alignment timer (TimeAlignmentTimer) is associated with the PTAG, the MAC layer may perform the following operations:
flush all HARQ buffers for all serving cells;
notify RRC to release PUCCH for all serving cells (if configured);
notify RRC to release SRS for all serving cells (if configured);
clear any configured downlink assignments and configured uplink grants;
clear any PUSCH resources for semi-persistent CSI reporting;
consider all running time-alignment timers as expired; and
maintain N_{TA} of all TAGS.

Otherwise, in a case where the time-alignment timer is associated with the STAG, for all serving cells belonging to this TAG:
flush all HARQ buffers;
notify RRC to release PUCCH (if configured);
notify RRC to release SRS (if configured);
clear any configured downlink assignments and configured uplink grants;
clear any PUSCH resource for semi-persistent CSI reporting; and
maintain N_{TA} of this TAG.

The other one is to reserve the uplink resources associated with all the target TRPs. Since there is still a TRP(s) being in the uplink in-sync state, the network device can transmit signaling through the TRP(s), so that uplink synchronization between the terminal device and the uplink out-of-sync target TRP can be re-established, thereby avoiding signaling overhead of repeated allocation of the uplink resources.

A process for transmitting the PRACH by the terminal device to the multiple TRPs will be described in detail.

In an embodiment of the disclosure, in a case where the at least one target TRP is implemented as multiple target TRPs, at 520, transmitting, by the terminal device, the PRACH to the at least one target TRP based on the random access parameter for the at least one target TRP can be implemented in any one of the following manners. The terminal device transmits a PRACH for each of the at least one target TRP to each of the multiple target TRPs based on a first transmission mode. The first transmission mode indicates that the terminal device is to transmit the PRACH for each of the at least one target TRP to each of the at least one target TRP based on a random access parameter for each of the multiple TRPs. The terminal device repeats transmission of a PRACH for each of the at least one target TRP to the multiple target TRPs based on a second transmission mode, where the second transmission mode is an FDM transmission mode. The terminal device repeats transmission of a PRACH for each of the at least one target TRP to the multiple target TRPs based on a third transmission mode, where the third transmission mode is a TDM transmission mode. The terminal device simultaneously transmits a PRACH for each of the at least one target TRP to the multiple target TRPs based on a fourth transmission mode, where the fourth transmission mode is an SFN transmission mode.

In some embodiments, a manner for obtaining the TA by the terminal device from the multiple target TRPs may be independent transmission of the PRACH. In embodiments of the disclosure, the first transmission mode is a manner for independent transmission of the PRACH to each target TRP by the terminal device. It may be understood that, the terminal device may transmit the PRACH to a corresponding target TRP based on the random access parameter for each target TRP determined at 510. During independent transmission of the PRACH to each TRP, the PRACH for each target TRP may correspond to a different transmission beam (for a different target TRP), a different RO resource, and a different preamble.

Optionally, in a case where each target TRP is associated with one independent time-alignment timer, when the multiple time-alignment timers expire, the terminal device may independently transmit the PRACH in the first transmission mode.

In addition, a manner for obtaining the TA by the terminal device from the multiple target TRPs may also be repetitions of the PRACH. The same preamble may be used for two or more repetitions of the PRACH, while different transmission beams and RO resources may be used for two or more repetitions of the PRACH.

Optionally, a multiplexing mode for two or more repetitions of the PRACH may be the second transmission mode (i.e., FDM) or the third transmission mode (i.e., TDM).

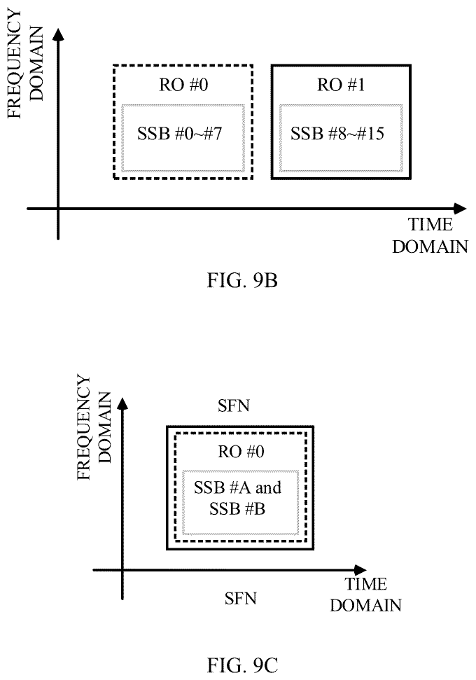

As illustrated in FIG. 9A, the second transmission mode may mean that the terminal device simultaneously transmits the PRACH to the multiple TRPs (only two TRPs are illustrated in FIG. 9A) over the same time-domain resource (for example, a slot, a sub-slot, a time-domain symbol, or the like) and different frequency-domain resources. The above time-domain resource and frequency-domain resources are pre-configured based on different RO resources, and a transmission beam for each target TRP may be a reception beam for reception of an SSB selected for that TRP.

As illustrated in FIG. 9B, the third transmission mode may mean that the terminal device transmits the PRACH to the multiple TRPs (only two TRPs are illustrated in FIG. 9B) over the same frequency-domain resource and different time-domain resources. The above time-domain resources and frequency-domain resource are pre-configured based on different RO resources, and the transmission beam for each target TRP may be a reception beam for reception of an SSB selected for that TRP.

In embodiments of the disclosure, a manner for obtaining the TA by the terminal device from the multiple target TRPs may further be SNF transmission of the PRACH, i.e., the above fourth transmission mode.

As illustrated in FIG. 9C, the fourth transmission mode may mean that the terminal device simultaneously transmits the same PRACH to the multiple target TRPs over the same time-frequency resource but transmits the same PRACH to the multiple TRPs over different transmission beams. By doing so, the multiple target TRPs can be combined for reception, and thus the reliability of uplink transmission can be improved.

It may be noted that, for the fourth transmission mode, the terminal device selects a corresponding SSB according to each uplink out-of-sync target TRP. Here, it may be noted that the selected two SSBs correspond to one RO resource, the same preamble is used to generate the PRACH, but two different transmission beams are used (since the RO resource is associated with two SSBs from different TRPs).

It may be noted that, the above four transmission modes may be applied to random access triggered by the time-alignment timer or random access triggered by the network device through indication information, which will not be limited in embodiments of the disclosure.

It may be understood that, which one of the four transmission modes is to be used by the terminal device may be configured by the network device or selected by the terminal device according to a capability of the terminal device, which will not be limited in embodiments of the disclosure.

Optionally, in the method for random access provided in embodiments of the disclosure, the following operations may further be performed before the operations at 520. The terminal device receives third indication information, where the third indication information instructs the terminal device to transmit the PRACH in a target transmission mode, and the target transmission mode is any one of the first transmission mode, the second transmission mode, the third transmission mode, and the fourth transmission mode.

That is, when the multiple target TRPs are configured, the network device can configure for the terminal device a mode for transmission of the PRACH to the multiple target TRPs.

It may be understood that, in the second transmission mode, the third transmission mode, and the fourth transmission mode, the terminal device needs to transmit the PRACH over the same time-domain resource and/or frequency-domain resource, which places greater demands on radio-frequency implementation of the terminal device. Not all terminal devices can support the second transmission mode, the third transmission mode, and the fourth transmission mode.

Based on this, before transmission of the PRACH to the multiples target TRPs, the terminal device in embodiments of the disclosure may report the capability of the terminal device, so as to inform the network device whether the terminal device supports the above transmission modes.

Optionally, in the method for random access provided in embodiments of the disclosure, before receiving the third indication information, the terminal device may further perform the following operations. The terminal device transmits terminal capability information, where the terminal capability information indicates at least one of a capability of information transmission based on an FDM mode, a capability of information transmission based on TDM, or a capability of information transmission based on an SFN.

It may be understood that, only when the network device determines that the terminal device has the above capabilities, the network device may configure, through the third indication information, for the terminal device a transmission mode supported by the terminal capability.

It may be noted that, in a case where the network device indicates the random access parameters for each target TRP through the first indication information, the third indication information may indicate which one of the above transmission modes is to be used for the multiple target TRPs based on the RO resource index for the multiple target TRPs in the first indication information. It may be understood that in this case, the third indication information may be carried in the first indication information.

Alternatively, the third indication information may be carried in the second indication information. Alternatively, the third indication information may be independent information, which will not be limited in embodiments of the disclosure.

As can be seen, the terminal device can transmit the PRACH to the multiple target TRPs in an appropriate transmission mode according to the configuration of the network device, thereby improving the flexibility of PRACH transmission. In some embodiments, the terminal device can automatically select an appropriate transmission mode for transmission of the PRACH to the multiple TRPs according to the capability of the terminal device, so as to obtain TA information for the multiple TRPs. In this way, the flexibility of PRACH transmission can be improved, and signaling overhead in configuring the transmission mode by the network device through the third indication information can also be avoided.

In an embodiment of the disclosure, the method for random access provided in embodiments of the disclosure may further include the following. The terminal device receives fourth indication information from each of the at least one target TRP, where the fourth indication information indicates TA information for each of the at least one target TRP.

It may be understood that, the network device can receive, through each of the at least one target TRP, the PRACH transmitted to each target TRP. As such, each target TRP may perform delay measurement according to the received PRACH, so as to determine TA information for the uplink between each TRP and the terminal device. Further, each TRP of the network device may transmit to the terminal device the TA information for each TRP through the fourth indication information.

Optionally, the fourth indication information may be carried in an MAC RAR or MAC CE, which will not be limited in embodiments of the disclosure.

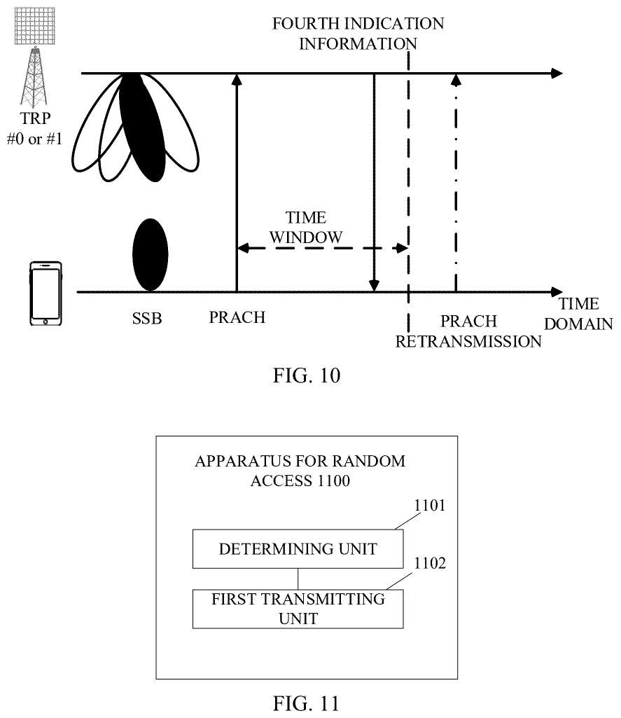

Optionally, as illustrated in FIG. 10, the terminal device can monitor the fourth indication information transmitted by each of the at least one target TRP in a time window for each of the at least one target TRP.

It may be noted that, the time window for each target TRP may be the same or different, which will not be limited in embodiments of the disclosure.

In embodiments of the disclosure, the time window for each target TRP may be pre-defined by a protocol or determined according to pre-configuration information or network configuration information, which will not be limited in embodiments of the disclosure.

Optionally, the network device can configure through an RRC message the time window for each target TRP, such as 10 ms and 100 ms. Exemplarily, the network device can carry time-window information in a field Time WindowForTA in the RRC message. Timing for the time window may start in time from a first symbol or slot after transmission of the PRACH.

Optionally, the method for random access provided in embodiments of the disclosure may further include the following. In a case where the terminal device does not receive the fourth indication information transmitted by the first target TRP in a time window for the first target TRP, the terminal device retransmits the PRACH to a first target TRP based on a random access parameter for the first target TRP. The first target TRP is any one of the at least one target TRP.

That is, in a case where the terminal device receives the fourth indication information transmitted by a corresponding TRP in the time window, the terminal device may consider the uplink synchronization with the TRP as completed. Otherwise, the terminal device retransmits a PRACH for the TRP after the end of the current time window. For retransmission of the PRACH, the terminal device may add a counter for retransmission of the PRACH by 1.

Optionally, the terminal device may also increase a transmission power for the PRACH, i.e., power ramping. For example, the terminal device increases the transmission power for the PRACH by 3 dB per retransmission, so that the TRP can receive the PRACH.

The current random access may be a four-step random access involving four-time interactions of random access messages: Msg.1 (PRACH), Msg.2 (RAR), Msg.3 (PUSCH), and Msg.4 (contention resolution). The current random access may be a two-step random access involving two-time interactions of random access messages: Msg.A and Msg.B. In addition to Msg.1 or Msg.A-based uplink synchronization, other information (such as SIB1) in the system for interaction may be further carried in the RACH procedure. Upon completion of initial access to the first TRP (the uplink in-sync TRP) among the multiple TRPs, the terminal device only needs to perform uplink synchronization for the target TRP (the uplink out-of-sync TRP). Therefore, omitting of repeated system information exchange during the random access may also be taken into consideration.

That is, in a case where the terminal device transmits the PRACH to obtain TA information for a certain TRP, the terminal device can use a simplified random access.

In embodiments of the disclosure, before transmitting the PRACH to a target TRP, the terminal device may inform the TRP in a specific manner whether transmission of the PRACH by the terminal device is to trigger a simplified random access or a normal random access.

In some embodiments, the terminal device may transmit fifth indication information to the first target TRP and indicate, through the fifth indication information, that the terminal device is to use a simplified random access for the first target TRP.

It may be noted that, the simplified random access indicates that the terminal device is to obtain only TA information for the first target TRP.

It may be understood that, in a case where the terminal device is to obtain only TA information specific to the first target TRP, the terminal device may inform its intention through the fifth indication information during transmission of the PRACH to the first target TRP.

Optionally, the fifth indication information may be carried in the PRACH. Exemplarily, when the PRACH contains the fifth indication information, it may indicate that the terminal device is to use the simplified random access for the first target TRP. When the PRACH does not contain the fifth indication information, it may indicate that the terminal device is to use the normal random access for the first target TRP. Alternatively, when the value of a codeword of a field where the fifth indication information in the PRACH is located is a first value, it may indicate that the terminal device is to use the simplified random access for the first target TRP. When the value of the codeword of the field where the fifth indication information in the PRACH is located is a second value, it may indicate that the terminal device is to use the normal random access for the first target TRP. An indication manner of the fifth indication information will not be limited in embodiments of the disclosure.

In some other embodiments, the terminal device may indicate that the terminal device is to use a simplified random access for a first target TRP, by setting a preamble in a preset preamble set as a preamble for the first target TRP and/or setting a resource in a preset resource set as an RO resource for the first target TRP.

In some embodiments, the network may group a certain number of preambles in advance into a preset preamble set, where preambles in the preset preamble set are used exclusively for the simplified random access. That is, when the terminal device transmits the PRACH to the first target TRP by using a preamble in the preset preamble set, it may be considered that the terminal device expects the simplified random access.

In some embodiments, the network device may also group a certain number of RO resources in advance (which may be implemented based on the PRACH mask index) into a preset resource set, where RO resources in the preset resource set are used exclusively for the simplified random access. That is, when the terminal device transmits the PRACH to the first target TRP over an RO resource in the preset resource set, it may be considered that the terminal device expects the simplified random access.

In some embodiments, the network device may also combine the preset preamble set and the preset resource set. When the terminal device transmits the PRACH to the first target TRP by using the preamble in the preset preamble set and the RO resource in the preset resource set, it may be considered that the terminal device expects the simplified random access.

It may be noted that, during the simplified random access, the terminal device and the network device can skip the repeated system information exchange during the normal random access, thereby reducing signaling overhead and improving the efficiency of random access. In addition, for the four-step random access, after transmission of the TA information through MAC RAR information, the terminal device and the network device can skip interactions of Msg.3 (PUSCH) and Msg.4 (contention resolution), further reducing signaling overhead.

It may be noted that, one or more first target TRPs may be configured. That is, the terminal device may implement a simplified random access for the one or more target TRPs.

The preferred embodiments of the disclosure have been described in detail above in connection with the accompanying drawings. However, the present disclosure is not limited to the details of the above embodiments. Various simple modifications can be made to the technical solution of the disclosure within the scope of the technical concept of the disclosure, and such simple modifications shall be within the protection scope of the present disclosure. For example, all the technical features described in the above embodiments can be combined with each other in any proper manner without conflict. In order to avoid unnecessary repetition, various manners of combination will not be elaborated in the disclosure. For another example, various embodiments of the disclosure can also be randomly combined without departing from the spirit of the present disclosure, and such combination should also be regarded as content disclosed by the present disclosure. For another example, various embodiments and/or technical features of the various embodiments may be implemented in any combination with the related art without conflict, and technical solutions thus obtained shall also fall within the protection scope of the disclosure.

It may also be understood that, in various method embodiments of the disclosure, the magnitude of a sequence number of each of the foregoing processes does not mean an execution order, and an execution order of each process may be determined according to a function and an internal logic of the process, which shall not constitute any limitation to an implementation process of embodiments of the disclosure. In addition, in embodiments of the disclosure, the terms “downlink”, “uplink”, and “sidelink” indicate a transmission direction of a signal or data, where “downlink” indicates that a transmission direction of a signal or data is a first direction from a station to a UE in a cell, “uplink” indicates that a transmission direction of a signal or data is a second direction from a UE in a cell to a station, and “sidelink” indicates that a transmission direction of a signal or data is a third direction from UE1 in a cell to UE2 in a cell. For example, a “downlink signal” indicates that a transmission direction of the signal is the first direction. Furthermore, in embodiments of the disclosure, the term “and/or” herein only describes an association relationship between associated objects, which means that there can be three relationships. Specifically, A and/or B can mean A alone, both A and B exist, and B alone. Besides, the character “/” herein generally indicates that the associated objects are in an “or” relationship.

FIG. 11 is a schematic structural diagram of an apparatus 1100 for random access provided in embodiments of the disclosure. The apparatus for random access is applied to a terminal device. As illustrated in FIG. 11, the apparatus for random access includes a determining unit 1101 and a first transmitting unit 1102. The determining unit 1101 is configured to determine a random access parameter for at least one target TRP, where each of the at least one target TRP is a TRP among multiple TRPs, where an uplink between the TRP and the terminal device is in an out-of-sync state, and at least part of random access parameters for different TRPs are different. The first transmitting unit 1102 is configured to transmit a PRACH to the at least one target TRP based on the random access parameter for the at least one target TRP, where the PRACH is used to obtain TA information for the at least one target TRP.

Optionally, the random access parameter includes at least one of a preamble, a transmission beam, or an RO.

Optionally, the determining unit 1101 is further configured to determine from multiple groups a target group associated with each of the at least one target TRP, where the multiple groups include multiple signal groups and/or multiple resource groups, the multiple signal groups contain signals for downlink synchronization, and the multiple resource groups contain resources for random access. The determining unit 1101 is further configured to select a target parameter from the target group associated with each of the at least one target TRP, to obtain a target parameter for each of the at least one target TRP. The determining unit 1101 is further configured to determine a random access parameter for each of the at least one target TRP based on the target parameter for each of the at least one target TRP.

Optionally, the multiple signal groups include SSB groups and/or TRS groups, the different SSB groups contain SSBs with different indexes, and the different TRS groups contain TRSs with different indexes. The multiple resource groups include RO groups, and the different RO groups contain ROs with different indexes.

Optionally, the multiple groups are in one-to-one correspondence with the multiple TRPs. The determining unit 1101 is further configured to select, based on a first correspondence, from the multiple groups a group associated with each of the at least one target TRP, to obtain the target group associated with each of the at least one target TRP. The first correspondence indicates a correspondence between the multiple groups and the multiple TRPs.

Optionally, the first correspondence is pre-defined by a protocol or determined according to pre-configuration information or network configuration information.

Optionally, the multiple groups have no correspondence with the multiple TRPs. The determining unit 1101 is further configured to determine a group to which a parameter associated with a first TRP belongs, to obtain a reference group, where the first TRP is a TRP among the multiple TRPs, where an uplink between the TRP and the terminal device is in an in-sync state. The determining unit 1101 is further configured to determine other groups except the reference group as target groups associated with the at least one target TRP, where each of the at least one target TRP corresponds to one of the other groups.

Optionally, the multiple groups are pre-defined by a protocol or determined according to pre-configuration information or network configuration information.

Optionally, the determining unit 1101 is further configured to receive first indication information, where the first indication information indicates a random access parameter for each of the at least one target TRP.

Optionally, the first indication information includes at least one of: a preamble index for each of the at least one target TRP, an RO resource index for each of the at least one target TRP, an SSB index for each of the at least one target TRP, or PCI information associated with each of the at least one target TRP. The SSB index for each of the at least one target TRP is used to determine a transmission beam for each of the at least one target TRP.

Optionally, in a case where the terminal device transmits the PRACH over an SFN, the first indication information includes at least one of: a first preamble index, a first RO resource index, an SSB index for each of the at least one target TRP, or PCI information associated with each of the at least one target TRP. The first preamble index indicates a preamble for each of the at least one target TRP. The first RO resource index indicates an RO resource for each of the at least one target TRP. The SSB index for each of the at least one target TRP is used to determine a transmission beam for each of the at least one target TRP.

Optionally, the first indication information is carried in first DCI, and the first DCI is used to trigger random access at the terminal device.

Optionally, the at least one target TRP is implemented as multiple target TRPs, the first DCI contains a unified TCI field, and the unified TCI field indicates an SSB index for any one of the multiple target TRPs.

Optionally, the terminal device is configured with at least one time-alignment timer, and each of the at least one time-alignment timer is associated with at least one of the multiple TRPs. The at least one target TRP is at least one TRP associated with one or more of the at least one time-alignment timer that expire. Alternatively, the at least one target TRP is indicated by second indication information.

Optionally, the determining unit 1101 is further configured to determine to clear/release an uplink resource associated with the at least one target TRP, or determine to reserve the uplink resource associated with the at least one target TRP, in a case where one or more of at least one time-alignment timer are determined as expired, the multiple TRPs include a first TRP, and the first TRP is a TRP, where an uplink between the TRP and the terminal device is in an in-sync state. The at least one target TRP is at least one TRP associated with the one or more of the at least one time-alignment timer that expire.

Optionally, the at least one target TRP is implemented as multiple target TRPs. The first transmitting unit 1102 is further configured to perform any one of the following. The terminal device transmits a PRACH for each of the at least one target TRP to each of the multiple target TRPs based on a first transmission mode, where the first transmission mode indicates that the terminal device is to transmit the PRACH for each of the at least one target TRP to each of the at least one target TRP based on a random access parameter for each of the multiple TRPs. The terminal device repeats transmission of a PRACH for each of the at least one target TRP to the multiple target TRPs based on a second transmission mode, where the second transmission mode is an FDM transmission mode. The terminal device repeats transmission of a PRACH for each of the at least one target TRP to the multiple target TRPs based on a third transmission mode, where the third transmission mode is a TDM transmission mode. The terminal device simultaneously transmits a PRACH for each of the at least one target TRP to the multiple target TRPs based on a fourth transmission mode, where the fourth transmission mode is an SFN transmission mode.

Optionally, the apparatus 1100 for random access further includes a first receiving unit. The first receiving unit is configured to receive third indication information, where the third indication information instructs the terminal device to transmit the PRACH in a target transmission mode, and the target transmission mode is any one of the first transmission mode, the second transmission mode, the third transmission mode, and the fourth transmission mode.

Optionally, the first transmitting unit 1102 is further configured to transmit terminal capability information. The terminal capability information indicates at least one of a capability of information transmission based on an FDM mode, a capability of information transmission based on TDM, or a capability of information transmission based on an SFN.

Optionally, the first receiving unit is further configured to receive fourth indication information from each of the at least one target TRP. The fourth indication information indicates TA information for each of the at least one target TRP.

Optionally, the apparatus 1100 for random access further includes a monitoring unit. The monitoring unit is configured to monitor the fourth indication information transmitted by each of the at least one target TRP in a time window for each of the at least one target TRP.

Optionally, the first transmitting unit 1102 is further configured to retransmit the PRACH to a first target TRP based on a random access parameter for the first target TRP, in a case where the fourth indication information transmitted by the first target TRP is not received in a time window for the first target TRP. The first target TRP is any one of the at least one target TRP.

Optionally, the first transmitting unit 1102 is further configured to transmit fifth indication information to a first target TRP. The fifth indication information indicates that the terminal device is to use a simplified random access for the first target TRP, and the first target TRP is any one of the at least one target TRP.

Optionally, the terminal device indicates that the terminal device is to use a simplified random access for a first target TRP, by setting a preamble in a preset preamble set as a preamble for the first target TRP and/or setting a resource in a preset resource set as an RO for the first target TRP.

Optionally, the simplified random access indicates that the terminal device is to obtain only TA information for the first target TRP.

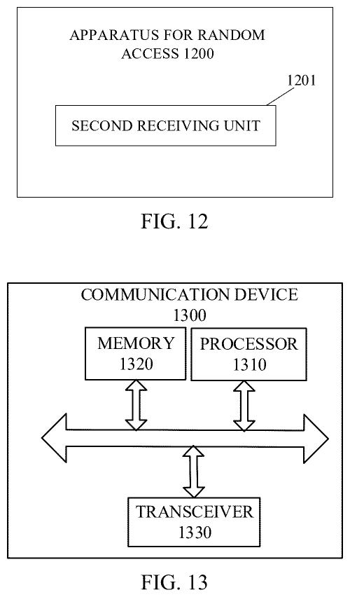

FIG. 12 is a schematic structural diagram of an apparatus 1200 for random access provided in embodiments of the disclosure. The apparatus for random access is applied to a network device. As illustrated in FIG. 12, the apparatus 1200 for random access includes a second receiving unit 1201. The second receiving unit 1201 is configured to receive, through each of at least one target TRP, a PRACH transmitted by a terminal device to each of the at least one target TRP. The PRACH is used to obtain TA information for each of the at least one target TRP, and each of the at least one target TRP is a TRP among multiple TRPs, where an uplink between the TRP and the terminal device is in an out-of-sync state.

Optionally, the random access parameter includes at least one of a preamble, a transmission beam, or an RO.

Optionally, a random access parameter for each of the at least one target TRP is determined based on a target parameter in a target group associated with each of the at least one target TRP, and the target parameter is any one of multiple parameters in the target group. The target group is any one of multiple groups; the multiple groups include multiple signal groups and/or multiple resource groups, the multiple signal groups contain signals for downlink synchronization, and the multiple resource groups contain resources for random access.

Optionally, the multiple signal groups include SSB groups and/or TRS groups, the different SSB groups contain SSBs with different indexes, and the different TRS groups contain TRSs with different indexes. The multiple resource groups include RO groups, and the different RO groups contain ROs with different indexes.

Optionally, the multiple groups are in one-to-one correspondence with the multiple TRPs. The target group associated with each of the at least one target TRP is determined based on a first correspondence, where the first correspondence indicates a correspondence between the multiple groups and the multiple TRPs.

Optionally, the first correspondence is pre-defined by a protocol or determined according to pre-configuration information or network configuration information.

Optionally, the multiple groups have no correspondence with the multiple TRPs. The target group associated with each of the at least one target TRP is determined according to other groups except a reference group, where the reference group is a group to which a parameter associated with a first TRP belongs, and the first TRP is a TRP among the multiple TRPs, where an uplink between the TRP and the terminal device is in an in-sync state.

Optionally, the multiple groups are pre-defined by a protocol or determined according to pre-configuration information or network configuration information.

Optionally, the apparatus 1200 for random access further includes a second transmitting unit. The second transmitting unit is configured to transmit first indication information to the terminal device, where the first indication information indicates a random access parameter for each of the at least one target TRP.

Optionally, the first indication information includes at least one of: a preamble index for each of the at least one target TRP, an RO resource index for each of the at least one target TRP, an SSB index for each of the at least one target TRP, or PCI information associated with each of the at least one target TRP. The SSB index for each of the at least one target TRP is used to determine a transmission beam for each of the at least one target TRP.

Optionally, in a case where the terminal device transmits the PRACH over an SFN, the first indication information includes at least one of: a first preamble index, a first RO resource index, an SSB index for each of the at least one target TRP, or PCI information associated with each of the at least one target TRP. The first preamble index indicates a preamble for each of the at least one target TRP. The first RO resource index indicates an RO resource for each of the at least one target TRP. The SSB index for each of the at least one target TRP is used to determine a transmission beam for each of the at least one target TRP.

Optionally, the first indication information is carried in first DCI, and the first DCI is used to trigger random access at the terminal device.

Optionally, the at least one target TRP is implemented as multiple target TRPs, the first DCI contains a unified TCI field, and the unified TCI field indicates an SSB index for any one of the multiple target TRPs.

Optionally, the second transmitting unit is further configured to transmit second indication information to the terminal device, where the second indication information indicates the at least one target TRP.

Optionally, the second transmitting unit is further configured to transmit third indication information to the terminal device. The third indication information instructs the terminal device to transmit the PRACH in a target transmission mode, and the target transmission mode is any one of a first transmission mode, a second transmission mode, a third transmission mode, and a fourth transmission mode. The first transmission mode indicates that the terminal device is to transmit a PRACH for each of the at least one target TRP to each of the at least one target TRP based on a random access parameter for each of the multiple TRPs. The second transmission mode is an FDM transmission mode. The third transmission mode is a TDM transmission mode. The fourth transmission mode is an SFN transmission mode.

Optionally, the second receiving unit 1201 is further configured to receive terminal capability information from the terminal device. The terminal capability information indicates at least one of a capability of information transmission based on an FDM mode, a capability of information transmission based on TDM, or a capability of information transmission based on an SFN.

Optionally, the second transmitting unit is further configured to transmit, through each of the at least one target TRP, fourth indication information of each of the multiple TRPs. The fourth indication information indicates TA information for the at least one target TRP.

Optionally, the second receiving unit 1201 is further configured to receive, through a first target TRP, fifth indication information transmitted by the terminal device to the first target TRP. The fifth indication information indicates that the terminal device is to use a simplified random access for the first target TRP.

Optionally, in a case where a preamble for a PRACH for a first target TRP is a preamble in a preset preamble set and/or an RO for the PRACH for the first target TRP is a resource in a preset resource set, the network device determines that the terminal device is to use a simplified random access for the first target TRP.

Optionally, the simplified random access indicates that the terminal device is to obtain only TA information for the first target TRP.

Those of skill in the art may understand that, for related illustration of the above apparatus for random access in embodiments of the disclosure, reference can be made to the related illustration of the method for random access in embodiments of the disclosure.

FIG. 13 is a schematic structural diagram of a communication device 1300 provided in embodiments of the disclosure. The communication device may be a terminal device or a network device. The communication device 1300 illustrated in FIG. 13 includes a processor 1310. The processor 1310 may be configured to invoke and run computer programs from a memory to perform the method in embodiments of the disclosure.

Optionally, as illustrated in FIG. 13, the communication device 1300 may further include a memory 1320. The processor 1310 may be configured to invoke and run computer programs from the memory 1320 to perform the method in embodiments of the disclosure.

The memory 1320 may be a separate device independent of the processor 1310, or may be integrated into the processor 1310.

Optionally, as illustrated in FIG. 13, the communication device 1300 may further include a transceiver 1330. The processor 1310 can control the transceiver 1330 to communicate with other devices. Specifically, the transceiver 1330 can transmit information or data to other devices, or receive information or data transmitted by other devices.

The transceiver 1330 may include a transmitter and a receiver. The transceiver 1330 may further include one or more antennas.

Optionally, the communication device 1300 may specifically be the network device in the embodiments of the disclosure, and the communication device 1300 can implement the corresponding process implemented by the network device in each of the methods of the embodiments of the disclosure, which will not be repeated herein for the sake of simplicity.

Optionally, the communication device 1300 may specifically be the terminal device in the embodiments of the disclosure, and the communication device 1300 can implement the corresponding process implemented by the terminal device in each of the methods of the embodiments of the disclosure, which will not be repeated herein for the sake of simplicity.

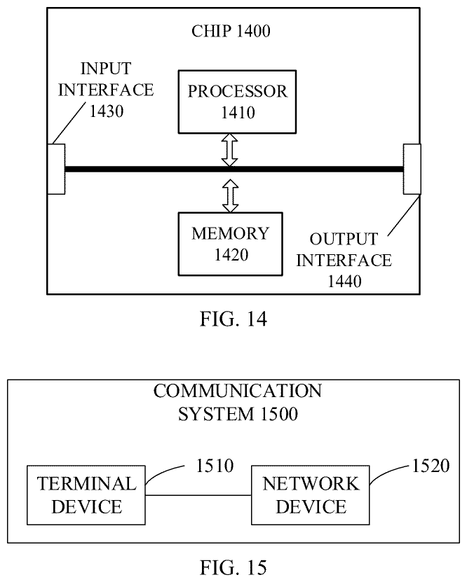

FIG. 14 is a schematic structural diagram of a chip provided in embodiments of the disclosure. The chip 1400 illustrated in FIG. 14 includes a processor 1410. The processor 1410 is configured to invoke and run computer programs from a memory to perform the method in embodiments of the disclosure.

Optionally, as illustrated in FIG. 14, the chip 1400 may further include a memory 1420. The processor 1410 may be configured to invoke and run computer programs from the memory 1420 to perform the method in embodiments of the disclosure.

The memory 1420 may be a separated device independent of the processor 1410, or may be integrated into the processor 1410.

Optionally, the chip 1400 may further include an input interface 1430. The processor 1410 can control the input interface 1430 to communicate with other devices or chips. Specifically, the input interface 1430 can obtain information or data transmitted by other devices or chips.

Optionally, the chip 1400 may further include an output interface 1440. The processor 1410 can control the output interface 1440 to communicate with other devices or chips. Specifically, the output interface 1440 can output information or data to other devices or chips.

Optionally, the chip may be applied to the network device in the embodiments of the disclosure, and the chip can implement the corresponding process implemented by the network device in each of the methods of the embodiments of the disclosure, which will not be repeated herein for the sake of simplicity.

Optionally, the chip may be applied to the mobile terminal/terminal device in embodiments of the disclosure, and the chip can implement the corresponding process implemented by the mobile terminal/terminal device in each of the methods in the embodiments of the disclosure, which will not be repeated herein for the sake of simplicity.

It may be understood that, the chip mentioned in the embodiments of the disclosure may also be referred to as a system-level chip, a system chip, a chip system, a system-on-a-chip chip, or the like.

FIG. 15 is a schematic block diagram illustrating a communication system 1500 provided in embodiments of the disclosure. As illustrated in FIG. 15, the communication system 1500 includes a terminal device 1510 and a network device 1520.

The terminal device 1510 can be configured to implement the corresponding functions implemented by the terminal device in the method above, and the network device 1520 can be configured to implement the corresponding functions implemented by the network device in the method above, which will not be repeated herein for the sake of simplicity.

It may be understood that, the processor in embodiments of the disclosure may be an integrated circuit chip with signal processing capabilities. During implementation, each step of the foregoing method may be completed by an integrated logic circuit of hardware in the processor or an instruction in the form of software. The processor may be a general-purpose processor, a digital signal processor (DSP), an application specific integrated circuit (ASIC), a field programmable gate array (FPGA), or other programmable logic devices, discrete gates or transistor logic devices, discrete hardware components. The methods, steps, and logic blocks disclosed in embodiments can be implemented or executed. The general purpose processor may be a microprocessor, or the processor may be any conventional processor or the like. The steps of the method disclosed in embodiments may be directly implemented as a hardware decoding processor, or may be performed by hardware and software modules in the decoding processor. The software module can be located in a storage medium such as a random access memory (RAM), a flash memory, a read only memory (ROM), a programmable ROM (PROM), or an electrically erasable programmable memory, registers, and the like. The storage medium is located in the memory. The processor reads the information in the memory, and completes the steps of the above-mentioned method with the hardware thereof.

It may be understood that, the memory may be a volatile memory or a non-volatile memory, or may include both the volatile memory and the non-volatile memory. The non-volatile memory may be an ROM, a PROM, an erasable PROM (EPROM), an electrically EPROM (EEPROM), or a flash memory. The volatile memory can be an RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). The memory of the system and the method described herein is intended to include, but is not limited to, these and any other suitable types of memory.

It may be understood that, the above description of the memory is intended for illustration rather than limitation. For example, the memory of embodiments may also be an SRAM, a DRAM, an SDRAM, a DDR SDRAM, an ESDRAM, an SLDRAM, a DR RAM, and so on. In other words, the memory of embodiments is intended to include, but is not limited to, these and any other suitable types of memory.

A computer-readable storage medium is further provided in embodiments of the disclosure. The computer readable storage medium is configured to store computer programs.

Optionally, the computer-readable storage medium is applicable to the network device in the embodiments of the disclosure. The computer programs are operable with a computer to implement the corresponding process implemented by the network device described in each of the methods of the embodiments of the disclosure, which will not be repeated herein for the sake of simplicity.

Optionally, the computer-readable storage medium is applicable to the mobile terminal/terminal device in the embodiments of the disclosure. The computer programs are operable with a computer to implement the corresponding process implemented by the mobile terminal/terminal device described in each of the methods of the embodiments of the disclosure, which will not be repeated herein for the sake of simplicity.

A computer program product is further provided in embodiments of the disclosure. The computer program product includes computer program instructions.

Optionally, the computer program product is applicable to the network device in the embodiments of the disclosure. The computer program instructions are operable with a computer to implement the corresponding process implemented by the network device in each of the methods of the embodiments of the disclosure, which will not be repeated herein for the sake of simplicity.

Optionally, the computer program product is applicable to the mobile terminal/terminal device in the embodiments of the disclosure. The computer program instructions are operable with a computer to implement the corresponding process implemented by the mobile terminal/terminal device described in each of the methods of the embodiments of the disclosure, which will not be repeated herein for the sake of simplicity.

A computer program is further provided in embodiments of the disclosure. Optionally, the computer program is applicable to the network device in the embodiments of the disclosure. The computer program, when executed by a computer, is operable with the computer to implement the corresponding process implemented by the network device in each of the methods of the embodiments of the disclosure, which will not be repeated herein for the sake of simplicity. Optionally, the computer program is applicable to the mobile terminal/terminal device in the embodiments of the disclosure. The computer program, when executed by a computer, is operable with the computer to implement the corresponding process implemented by the mobile terminal/terminal device in each of the methods of the embodiments of the disclosure, which will not be repeated herein for the sake of simplicity.

Those of ordinary skill in the art will appreciate that units and algorithmic operations of various examples described in connection with embodiments herein can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods may not be regarded as lying beyond the scope of the disclosure.

It will be evident to those skilled in the art that, for the sake of convenience and simplicity, in terms of the working processes of the foregoing systems, apparatuses, and units, reference can be made to the corresponding processes of the above method embodiments, which will not be repeated herein.

It will be appreciated that the systems, apparatuses, and methods disclosed in embodiments herein may also be implemented in various other manners. For example, the above apparatus embodiments are merely illustrative, e.g., the division of units is only a division of logical functions, and there may exist other manners of division in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device or unit, and may be electrical, mechanical, or otherwise.

Separated units as illustrated may or may not be physically separated. Components or parts displayed as units may or may not be physical units, and may reside at one location or may be distributed to multiple networked units. Some or all of the units may be selectively adopted according to practical needs to achieve desired objectives of the disclosure.

In addition, various functional units described in embodiments herein may be integrated into one processing unit or may be present as a number of physically separated units, and two or more units may be integrated into one.

If the functions are implemented as software functional units and sold or used as standalone products, they may be stored in a computer readable storage medium. Based on such an understanding, the essential technical solution, or the portion that contributes to the prior art, or all or part of the technical solution of the disclosure may be embodied as software products. The computer software products can be stored in a storage medium and may include multiple instructions that, when executed, can cause a computing device, e.g., a personal computer, a server, a network device, etc., or a processor to execute some or all operations of the methods described in various embodiments. The above storage medium may include various kinds of media that can store program codes, such as a universal serial bus (USB) flash disk, a mobile hard drive, an ROM, an RAM, a magnetic disk, or an optical disk.

The above are merely specific embodiments of the disclosure and are not intended to limit the scope of protection of the disclosure. Any modification and replacement made by those skilled in the art within the technical scope of the disclosure shall be included in the scope of protection of the disclosure. Therefore, the scope of protection of the disclosure may be stated in the scope of protection of the claims.

What is claimed is:

1. A method for random access, comprising:
determining, by a terminal device, a random access parameter for at least one target transmission reception point (TRP), wherein each of the at least one target TRP is a TRP among a plurality of TRPs, wherein an uplink between the TRP among the plurality of TRPs and the terminal device is in an out-of-sync state, and at least part of random access parameters for different TRPs are different; and
transmitting, by the terminal device, a physical random access channel (PRACH) to the at least one target TRP based on the random access parameter for the at least one target TRP, wherein the PRACH is used to obtain timing advance (TA) information for the at least one target TRP.

2. The method of claim 1, wherein the random access parameter comprises at least one of:
a preamble, a transmission beam, or a random access occasion (RO).

3. The method of claim 1, wherein determining, by the terminal device, the random access parameter for the at least one target TRP comprises:
determining, by the terminal device, from a plurality of groups a target group associated with each of the at least one target TRP, wherein the plurality of groups comprise a plurality of signal groups and/or a plurality of resource groups, the plurality of signal groups contain signals for downlink synchronization, and the plurality of resource groups contain resources for random access;
selecting, by the terminal device, a target parameter from the target group associated with each of the at least one target TRP, to obtain a target parameter for each of the at least one target TRP; and
determining, by the terminal device, a random access parameter for each of the at least one target TRP based on the target parameter for each of the at least one target TRP.

4. The method of claim 3, wherein the plurality of signal groups comprise synchronization signal and PBCH block (SSB) groups and/or tracking reference signal (TRS) groups, different SSB groups of the SSB groups contain SSBs with different indexes, and different TRS groups of the TRS groups contain TRSs with different indexes; and
wherein the plurality of resource groups comprise RO groups, and the different RO groups contain ROs with different indexes.

5. The method of claim 3, wherein the plurality of groups are in one-to-one correspondence with the plurality of TRPs; and
determining, by the terminal device, from the plurality of groups the target group associated with each of the at least one target TRP comprises:
selecting, by the terminal device based on a first correspondence, from the plurality of groups a group associated with each of the at least one target TRP, to obtain the target group associated with each of the at least one target TRP;
wherein the first correspondence indicates a correspondence between the plurality of groups and the plurality of TRPs.

6. The method of claim 1, wherein determining, by the terminal device, the random access parameter for the at least one target TRP among the plurality of TRPs comprises:
receiving, by the terminal device, first indication information, wherein the first indication information indicates a random access parameter for each of the at least one target TRP.

7. The method of claim 6, wherein the first indication information comprises at least one of:
a preamble index for each of the at least one target TRP;
an RO resource index for each of the at least one target TRP;
an SSB index for each of the at least one target TRP, wherein the SSB index for each of the at least one target TRP is used to determine a transmission beam for each of the at least one target TRP; or
physical cell identity (PCI) information associated with each of the at least one target TRP.

8. The method of claim 1, wherein the terminal device is configured with at least one time-alignment timer, and each of the at least one time-alignment timer is associated with at least one of the plurality of TRPs;
wherein the at least one target TRP is at least one TRP associated with one or more of the at least one time-alignment timer that expire; or
wherein the at least one target TRP is indicated by second indication information.

9. The method of claim 1, further comprising:
in a case where one or more of at least one time-alignment timer are determined as expired, the plurality of TRPs comprise a first TRP, and the first TRP is a TRP which is in uplink in-sync with the terminal device, determining, by the terminal device, to clear/release an uplink resource associated with the at least one target TRP; or determining, by the terminal device, to reserve the uplink resource associated with the at least one target TRP;
wherein the at least one target TRP is at least one TRP associated with the one or more of the at least one time-alignment timer that expire.

10. The method of claim 1, wherein the at least one target TRP is implemented as a plurality of target TRPs; and
transmitting, by the terminal device, the PRACH to the at least one target TRP based on the random access parameter for the at least one target TRP comprises any one of:
transmitting, by the terminal device, a PRACH for each of the at least one target TRP to each of the plurality of target TRPs based on a first transmission mode, wherein the first transmission mode indicates that the terminal device is to transmit the PRACH for each of the at least one target TRP to each of the at least one target TRP based on a random access parameter for each of the plurality of TRPs;
repeating, by the terminal device, transmission of a PRACH for each of the at least one target TRP to the plurality of target TRPs based on a second transmission mode, wherein the second transmission mode is a frequency division multiplexing (FDM) transmission mode;
repeating, by the terminal device, transmission of a PRACH for each of the at least one target TRP to the plurality of target TRPs based on a third transmission mode, wherein the third transmission mode is a time division multiplexing (TDM) transmission mode; and
transmitting simultaneously, by the terminal device, a PRACH for each of the at least one target TRP to the plurality of target TRPs based on a fourth transmission mode,
wherein the fourth transmission mode is an SFN transmission mode.

11. The method of claim 10, further comprising:
receiving, by the terminal device, third indication information, wherein the third indication information instructs the terminal device to transmit the PRACH in a target transmission mode, and the target transmission mode is any one of the first transmission mode, the second transmission mode, the third transmission mode, and the fourth transmission mode.

12. The method of claim 11, wherein before receiving, by the terminal device, the third indication information, the method further comprises:
transmitting, by the terminal device, terminal capability information, wherein the terminal capability information indicates at least one of:
a capability of information transmission based on an FDM mode, a capability of information transmission based on TDM, or a capability of information transmission based on an SFN.

13. The method of claim 1, further comprising:
receiving, by the terminal device, fourth indication information from each of the at least one target TRP, wherein the fourth indication information indicates TA information for each of the at least one target TRP.

14. A terminal device, comprising:
a transceiver configured for communication with a network device;
a processor coupled with the transceiver; and
a memory configured to store a computer program executable by the processor;
wherein the computer program, when executed by the processor, causes the terminal device to:
determine a random access parameter for at least one target transmission reception point (TRP), wherein each of the at least one target TRP is a TRP among a plurality of TRPs, wherein an uplink between the TRP among the plurality of TRPs and the terminal device is in an out-of-sync state, and at least part of random access parameters for different TRPs are different; and
transmit a physical random access channel (PRACH) to the at least one target TRP based on the random access parameter for the at least one target TRP, wherein the PRACH is used to obtain timing advance (TA) information for the at least one target TRP.

15. The terminal device of claim 14, wherein the random access parameter comprises at least one of:
a preamble, a transmission beam, or a random access occasion (RO).

16. The terminal device of claim 14, wherein the computer program executed by the processor to cause the terminal device to determine the random access parameter for the at least one target TRP is executed by the processor to cause the terminal device to:
determine, from a plurality of groups, a target group associated with each of the at least one target TRP, wherein the plurality of groups comprise a plurality of signal groups and/or a plurality of resource groups, the plurality of signal groups contain signals for downlink synchronization, and the plurality of resource groups contain resources for random access;
select a target parameter from the target group associated with each of the at least one target TRP, to obtain a target parameter for each of the at least one target TRP; and
determine a random access parameter for each of the at least one target TRP based on the target parameter for each of the at least one target TRP.

17. The terminal device of claim 16, wherein the plurality of signal groups comprise synchronization signal and PBCH block (SSB) groups and/or tracking reference signal (TRS) groups, different SSB groups of the SSB groups contain SSBs with different indexes, and different TRS groups of the TRS groups contain TRSs with different indexes; and
wherein the plurality of resource groups comprise RO groups, and the different RO groups contain ROs with different indexes.

18. A network device, comprising:
a transceiver configured for communication with a terminal device;
a processor coupled with the transceiver; and
a memory configured to store a computer program executable by the processor;
wherein the computer program, when executed by the processor, causes the terminal device to:
receive, through each of at least one target transmission reception point (TRP), a physical random access channel (PRACH) transmitted by the terminal device to each of the at least one target TRP, wherein the PRACH is used to obtain timing advance (TA) information for each of the at least one target TRP, and each of the at least one target TRP is a TRP among a plurality of TRPs, wherein an uplink between the TRP among the plurality of TRPs and the terminal device is in an out-of-sync state.

19. The network device of claim 18, wherein a random access parameter comprises at least one of:
a preamble, a transmission beam, or a random access occasion (RO).

20. The network device of claim 18, wherein a random access parameter for each of the at least one target TRP is determined based on a target parameter in a target group associated with each of the at least one target TRP; the target parameter is any one of a plurality of parameters in the target group; and
wherein the target group is any one of a plurality of groups; the plurality of groups comprise a plurality of signal groups and/or a plurality of resource groups, the plurality of signal groups contain signals for downlink synchronization, and the plurality of resource groups contain resources for random access.
